(19) United States
(12) Patent Application Publication
(10) Pub. No.: US 2026/0177385 A1
(43) Pub. Date: Jun. 25, 2026

(54) ANOMALY DETECTION METHOD, ANOMALY DETECTION DEVICE, AND RECORDING MEDIUM

(71) Applicant: Panasonic Intellectual Property Management Co., Ltd., Osaka (JP)

(72) Inventors: Hiroyuki OKADA, Osaka (JP); Tatsumi OBA, Chiba (JP); Tomoyuki HAGA, Nara (JP); Kentaro IIO, Fukuoka (JP); Takahiro YAMAGUCHI, Osaka (JP)

(73) Assignee: Panasonic Intellectual Property Management Co., Ltd., Osaka (JP)

(21) Appl. No.: 19/536,428

(22) Filed: Feb. 11, 2026

Related U.S. Application Data
(63) Continuation of application No. PCT/JP2024/026612, filed on Jul. 25, 2024.

(30) Foreign Application Priority Data
Aug. 25, 2023 (JP) 2023-137431

(51) Int. Cl. G01C 21/34; B60W 60/00; G06N 20/00

(52) U.S. Cl. CPC G01C 21/3407; B60W 60/001; G06N 20/00

(57) ABSTRACT

An anomaly detection method includes: an obtainment process for obtaining a travel route along which an autonomous vehicle has traveled from an origin up to a given time point; and a detection process for (i) reading out information regarding routes traversable by the autonomous vehicle from the origin to a destination, (ii) identifying, based on the information regarding the routes read out, one of the routes as an estimated travel route of the autonomous vehicle from the origin to the destination, (iii) calculating the degree of anomaly representing an extent to which the travel route up to the given time point deviates from the estimated travel route identified, and (iv) detecting an occurrence of an anomaly in the autonomous vehicle when the degree of anomaly calculated exceeds a predetermined threshold.

### CROSS REFERENCE TO RELATED APPLICATIONS

This is a continuation application of PCT International Application No. PCT/JP2024/026612 filed on Jul. 25, 2024, designating the United States of America, which is based on and claims priority of Japanese Patent Application No. 2023-137431 filed on Aug. 25, 2023. The entire disclosures of the above-identified applications, including the specifications, drawings and claims are incorporated herein by reference in their entirety.

### FIELD

The present disclosure relates to, for example, an anomaly detection method for detecting an anomaly concerning an autonomous vehicle.

### BACKGROUND

In recent years, various initiatives are underway to realize the practical implementation of autonomous vehicles. For instance, demonstration experiments are underway to test services that utilize autonomous vehicles for delivering goods and transporting people both indoors and outdoors and services utilizing autonomous vehicles, such as cleaning and security robots.

To provide safe services utilizing autonomous vehicles, it is necessary to communicate with a remote monitoring site to enable status monitoring and an emergency operation. However, enabling communication with a remote monitoring site may pose potential risks of cyberattacks. Because of this, an anomaly detection method that anticipates cyberattacks to autonomous vehicles has been proposed to decrease the risks of cyberattacks.

For instance, Patent Literature (PTL) 1 discloses a vehicle anomaly detection method utilizing location-specific features such as current vehicle position information.

### CITATION LIST

### Patent Literature

PTL 1: International Publication No. WO2021/149340

### SUMMARY

### Technical Problem

In the anomaly detection method disclosed in PTL 1, an optimal anomaly detection model suitable for the features of the location (for example, the difference between local roads and highways) is selected on the basis of current vehicle position information, and vehicle anomaly detection is performed using the selected anomaly detection model with the assumption that the current vehicle position information is correct.

However, if the current vehicle position information is not correct, for example, if the position information is manipulated by a cyber attacker, an optimal anomaly detection model cannot be selected. Consequently, anomaly detection might not be possible. Moreover, even if the current vehicle position information is correct and has not been manipulated, when a cyber attacker unlawfully manipulates the vehicle, causing it to head toward a location different from its intended destination, it is difficult to check whether the vehicle is in an abnormal location. As described above, there are aspects where anomaly detection for autonomous vehicles is inadequate.

In view of this, the present disclosure provides an anomaly detection method and so forth that enable more appropriate anomaly detection.

### Solution to Problem

An anomaly detection method according to one aspect of the present disclosure is an anomaly detection method for detecting an anomaly in an autonomous vehicle that autonomously travels from an origin to a destination. The anomaly detection method is performed by a computer and includes: an obtainment process for obtaining a travel route along which the autonomous vehicle has traveled from the origin up to a given time point; and a detection process for (i) reading out information regarding a plurality of routes traversable by the autonomous vehicle from the origin to the destination, (ii) identifying, based on the information regarding the plurality of routes read out, one of the plurality of routes as an estimated travel route of the autonomous vehicle from the origin to the destination, (iii) calculating a degree of anomaly representing an extent to which the travel route up to the given time point deviates from the estimated travel route identified, and (iv) detecting an occurrence of an anomaly in the autonomous vehicle when the degree of anomaly calculated exceeds a predetermined threshold.

Moreover, an anomaly detection device according to another aspect of the present disclosure is an anomaly detection device that detects an anomaly in an autonomous vehicle that autonomously travels from an origin to a destination. The anomaly detection device includes: an obtainer that obtains a travel route along which the autonomous vehicle has traveled from the origin up to a given time point; a memory section that stores information regarding a plurality of routes traversable by the autonomous vehicle from the origin to the destination; and an anomaly detector that (i) identifies, based on the information regarding the plurality of routes read out from the memory section, one of the plurality of routes as an estimated travel route of the autonomous vehicle from the origin to the destination, (ii) calculates a degree of anomaly representing an extent to which the travel route up to the given time point deviates from the estimated travel route identified, and (iii) detects an occurrence of an anomaly in the autonomous vehicle when the degree of anomaly calculated exceeds a predetermined threshold.

Moreover, a recording medium according to another aspect of the present disclosure is a non-transitory computer-readable recording medium having recorded thereon a program for causing the computer to execute the above anomaly detection method.

### Advantageous Effects

According to the above aspects, it is possible to more appropriately detect an anomaly in an autonomous vehicle.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of travel route selection for an autonomous vehicle.

FIG. 2 is a schematic diagram illustrating an example of travel route selection for an autonomous vehicle.

FIG. 3 is a configuration diagram illustrating an example of an overall configuration of an anomaly detection system in an embodiment.

FIG. 4 is a schematic diagram illustrating an example of map information in the embodiment.

FIG. 5 is a configuration diagram illustrating an example of a configuration of an anomaly detector in the embodiment.

FIG. 6 is a schematic diagram illustrating an example of a data structure of vehicle information in the embodiment.

FIG. 7 is a schematic diagram illustrating an example of a data structure of cargo information in the embodiment.

FIG. 8 is a schematic diagram illustrating an example of a data structure of weather information in the embodiment.

FIG. 9 is a schematic diagram illustrating an example of a data structure of road traffic information in the embodiment.

FIG. 10 is a schematic diagram illustrating an example of a data structure of operation management information in the embodiment.

FIG. 11 is a flowchart illustrating an example of operation of an anomaly detection process in the embodiment.

FIG. 12 is a schematic diagram illustrating an example of a combination of travel route determination parameters in the embodiment.

FIG. 13A is a schematic diagram illustrating an example of a data structure of an estimation model in the embodiment.

FIG. 13B is a schematic diagram illustrating an example of a data structure of the estimation model in the embodiment.

FIG. 14A is a schematic diagram illustrating an example of a data structure of an anomaly detection model in the embodiment.

FIG. 14B is a schematic diagram illustrating an example of a data structure of an anomaly detection model in the embodiment.

FIG. 14C is a schematic diagram illustrating an example of a data structure of an anomaly detection model in the embodiment.

FIG. 15 is a flowchart illustrating an example of operation of an anomaly detection model selection process in the embodiment.

FIG. 16 is a flowchart illustrating an example of operation of an anomaly determination process in the embodiment.

FIG. 17A is a schematic diagram illustrating an example of a procedure in the anomaly determination process in the embodiment.

FIG. 17B is a schematic diagram illustrating an example of the procedure in the anomaly determination process in the embodiment.

FIG. 18 is a schematic diagram illustrating an example of a data structure of anomaly detection results in the embodiment.

FIG. 19 is a configuration diagram illustrating an example of a configuration of a model trainer in the embodiment.

FIG. 20 is a flowchart illustrating an example of operation of a model training process in the embodiment.

FIG. 21A is a schematic diagram illustrating an example of information concerning travel routes from previous trips in the embodiment.

FIG. 21B is a schematic diagram illustrating an example of information concerning the travel routes from the previous trips in the embodiment.

FIG. 22 is a flowchart illustrating an example of operation of a travel route determination parameter grouping process in the embodiment.

FIG. 23A is an example of a histogram representing the usage frequency of each route from a previous trip in the embodiment.

FIG. 23B is an example of a histogram representing the usage frequency of each route from a previous trip in the embodiment.

FIG. 23C is an example of a histogram representing the usage frequency of each route from a previous trip in the embodiment.

FIG. 23D is an example of a histogram representing the usage frequency of each route from a previous trip in the embodiment.

FIG. 24 is a schematic diagram illustrating an example of a procedure in a travel route determination parameter grouping process in the embodiment.

FIG. 25 is a schematic diagram illustrating an example of a procedure in the travel route determination parameter grouping process in the embodiment.

FIG. 26 is a flowchart illustrating an example of operation of a travel route determination parameter importance calculation process in the embodiment.

FIG. 27A is a schematic diagram illustrating an example of a procedure in the travel route determination parameter importance calculation process in the embodiment.

FIG. 27B is a schematic diagram illustrating an example of a procedure in the travel route determination parameter importance calculation process in the embodiment.

FIG. 28 is a flowchart illustrating an example of operation of an anomaly detection model training process in the embodiment.

FIG. 29A is a schematic diagram illustrating an example of a procedure in the anomaly detection model training process in the embodiment.

FIG. 29B is a schematic diagram illustrating an example of the procedure in the anomaly detection model training process in the embodiment.

### DESCRIPTION OF EMBODIMENT

### Circumstances Leading to One Aspect of the Present Disclosure

While services utilizing autonomous vehicles are expanding as a solution to labor shortages, IoT-enabled autonomous vehicles are at risk of attackers gaining unauthorized access to their internal control systems, via a method such as network-based access or direct connection to the device. Once the control system is breached, a replay attack can be executed with simple commands. Thus, it is highly vulnerable to cyberattacks. As countermeasures, a number of anomaly detection devices and anomaly detection methods for remotely monitoring autonomous vehicle anomalies have been proposed.

However, in remote anomaly detection for autonomous vehicles, the variability in traveling patterns of an autonomous vehicle is leading to an increase in false detections, which is raising concerns. Given the large number of anomaly monitoring targets, suppressing false positives in anomaly detection has become a key challenge. Typically, in a target area or location, an autonomous vehicle determines the travel route to the destination on its own, recognizes and avoids obstructions by using light detection and ranging (Lidar) and camera information, and performs operations such as speed changes, turning, and activating turn signals. Thus, traveling patterns tend to be inconsistent, and a simple threshold determination method applied to speed information and the like results in a high number of false positives.

In view of this, as disclosed in PTL 1, an anomaly detection method has been developed which is capable of suppressing false positives by changing an anomaly detection model on the basis of the current vehicle position information, and performing anomaly detection more suitable for the features of the location. However, with the aforementioned anomaly detection method, there is a risk that an anomaly will go undetected in cases where: (i) the vehicle position information has been manipulated by an attacker, or (ii) the vehicle, while under malicious control by an attacker, is operated in a manner that shows no significant deviation from normal operation.

In view of the above, the inventors of the present application conceived that it is necessary to determine whether the current travel route and position of an autonomous vehicle traveling toward a preset destination are anomalous.

Meanwhile, to determine whether the current travel route of the autonomous vehicle is anomalous, information is required regarding the logic used to select and determine, from among multiple traversable routes, the actual travel route of the autonomous vehicle. As described above, for a set destination, the autonomous vehicle automatically determines an optimal travel route from the origin to the destination, by using map information showing a target area and a location. However, typically, information such as the logic concerning travel route determination is exclusively used by autonomous vehicle vendors and remains undisclosed, often functioning as a black box. As a result, it is difficult for service providers that perform remote monitoring and anomaly detection for vehicles to access these information items.

In view of this, the inventors of the present application hypothesized that it might be possible to estimate the logic for selecting and determining the travel route of an autonomous vehicle. To verify this hypothesis, they conducted driving demonstration experiments with an autonomous vehicle. Then, in the process of the demonstration experiments, the inventors discovered that even with the same combination of origin and destination, the travel route of an autonomous vehicle does not necessarily remain the same each time.

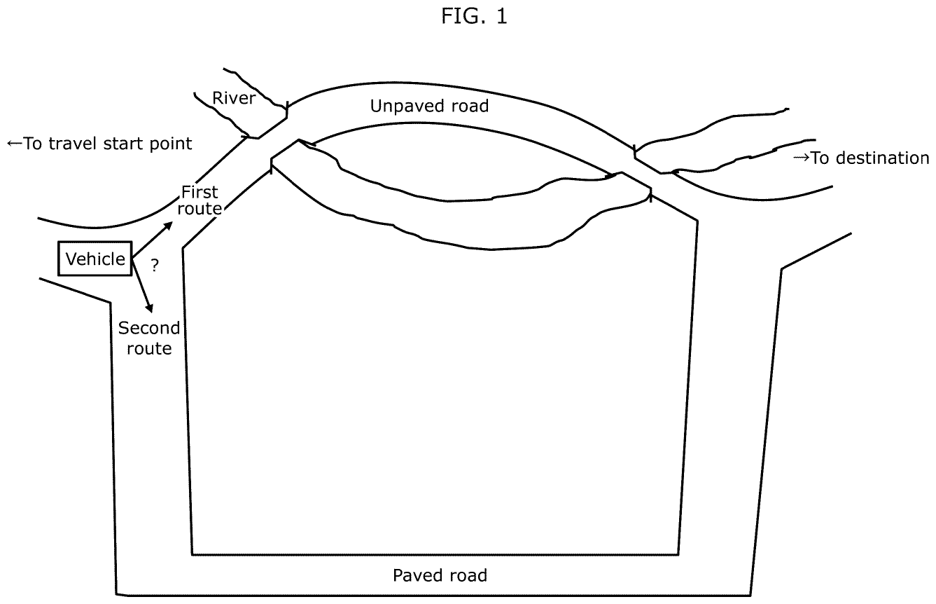

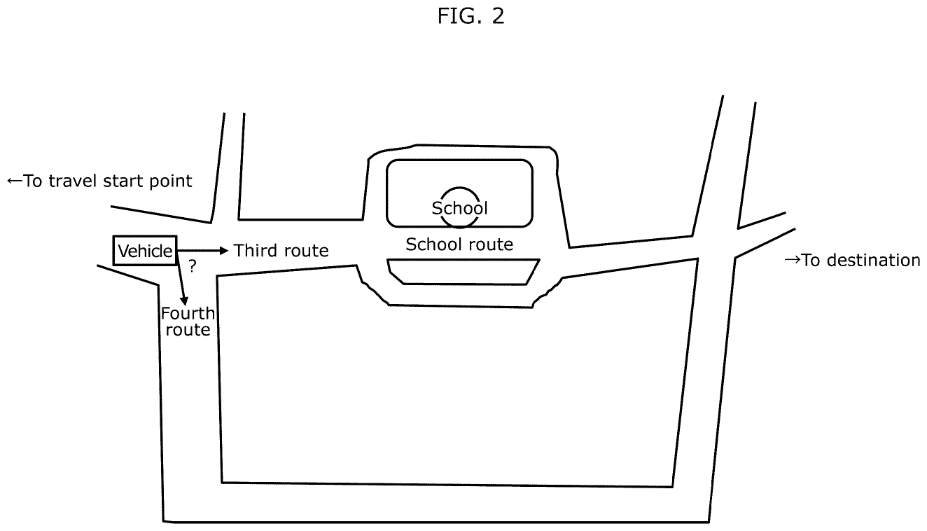

FIGS. 1 and 2 are schematic diagrams each illustrating an example of route selection when an autonomous vehicle used in a material-handling service is directed toward the destination as one demonstration experiment.

FIG. 1 illustrates two routes: one upper and one lower (a first route and a second route) from the travel start point to the destination and the divergence point of the two routes. Although the distance to the destination is shorter than that of the second route, the first route on the upper side includes a bridge over a river and an unpaved road. Although the distance to the destination is longer than that of the first route, the majority of the second route on the lower side is paved. Even for the same combination of origin and destination, the demonstration experiments observed both the case in which an autonomous vehicle traveled along the first route in FIG. 1, and the case in which the autonomous vehicle traveled along the second route in FIG. 1. For instance, in clear weather or when the cargo included perishable goods, the autonomous vehicle traveled along the first route, and in rainy weather or when the cargo included fragile goods, the autonomous vehicle traveled along the second route.

Here, when the first route, which has a shorter distance to the destination, is selected, it can be inferred that the autonomous vehicle's travel route was determined by prioritizing the shorter distance to the destination or the shorter travel time to the destination. By contrast, when the second route is selected, it can be inferred that as a result of prioritizing the condition regarding whether the travel route includes a high-risk area where river flooding may occur during adverse weather conditions, the autonomous vehicle's travel route was determined in a way that avoids selecting the first route including the bridge over the river, for example. Alternatively, it can be inferred that as a result of prioritizing the low vibration during the travel attributed to road surface conditions and related factors, the autonomous vehicle's travel route was determined in a way that avoids selecting the first route including the unpaved road, for example.

Moreover, FIG. 2 illustrates two routes: one upper and one lower (a third route and a fourth route) from the travel start point to the destination and the divergence point of the two routes. Although the distance to the destination is shorter than that of the fourth route, the third route on the upper side includes a school route. Although the distance to the destination is longer than that of the third route, the fourth route on the lower side does not include a school route. As with the example in FIG. 1, the example in FIG. 2 also shows that even for the same combination of origin and destination, the demonstration experiments observed both the case in which an autonomous vehicle traveled along the third route in FIG. 2, and the case in which the autonomous vehicle traveled along the fourth route in FIG. 2. For instance, when driving at night or when the cargo included perishable goods, the autonomous vehicle traveled along the third route, and during morning or evening hours or when the cargo included fragile goods, the autonomous vehicle traveled along the fourth route.

Here, when the third route, which has a shorter distance to the destination, is selected, it can be inferred that the autonomous vehicle's travel route was determined by prioritizing the shorter distance to the destination or the shorter travel time to the destination. By contrast, when the fourth route is selected, it can be inferred that as a result of prioritizing a low likelihood of accidents due to collisions or a low likelihood of delays in arrival to the destination caused by route congestion, the autonomous vehicle's travel route was determined in a way that avoids selecting the third route including the school route during school commuting hours, for example.

As described above, an autonomous vehicle's travel route is not determined solely based on the distance to the destination. For instance, it is considered that the travel route is determined in consideration of information such as the type of transported cargo and transportation conditions when an autonomous vehicle is used in a material-handling service, in addition to information such as route congestion levels depending on the time of day, accident risks, information on near-miss locations, the presence of roadworks, pavement conditions, and the effects of weather on the route.

In light of the foregoing, the present inventors have conducted extensive studies and found that a travel route selected and determined by an autonomous vehicle at the time of traveling is estimated by estimating information or factors that are considered by the autonomous vehicle when determining its travel route, in other words, travel route determination parameters. Then, the present inventors have found an anomaly detection method for selecting an optimal anomaly detection model that detects an anomaly on the basis of the estimated travel route and performing anomaly detection for the autonomous vehicle.

An anomaly detection method according to a first aspect of the present disclosure is an anomaly detection method for detecting an anomaly in an autonomous vehicle that autonomously travels from an origin to a destination. The anomaly detection method is performed by a computer and includes: an obtainment process for obtaining a travel route along which the autonomous vehicle has traveled from the origin up to a given time point; and a detection process for (i) reading out information regarding a plurality of routes traversable by the autonomous vehicle from the origin to the destination, (ii) identifying, based on the information regarding the plurality of routes read out, one of the plurality of routes as an estimated travel route of the autonomous vehicle from the origin to the destination, (iii) calculating a degree of anomaly representing an extent to which the travel route up to the given time point deviates from the estimated travel route identified, and (iv) detecting an occurrence of an anomaly in the autonomous vehicle when the degree of anomaly calculated exceeds a predetermined threshold.

Since the estimated travel route of the autonomous vehicle is identified, even if position information regarding the autonomous vehicle has been manipulated or an unauthorized operation is performed on the autonomous vehicle, it is possible to detect an anomaly on the basis of the estimated travel route. That is, if the traveled route of the autonomous vehicle up to the given time point deviates from the identified estimated travel route, it is possible to detect an occurrence of an anomaly.

Moreover, an anomaly detection method according a second aspect is the anomaly detection method according to the first aspect, in which the information regarding the plurality of routes is further obtained when the travel route up to the given time point is obtained or every time a predetermined duration has passed, and the information regarding the plurality of routes read out to identify the estimated travel route includes previously obtained information regarding the plurality of routes.

In this way, it is possible to update the information regarding the plurality of routes, and identify the estimated travel route corresponding to the status of each route that may change with time.

Moreover, an anomaly detection method according to a third aspect is the anomaly detection method according to the first or second aspect, in which the detection process further includes: displaying, when an anomaly in the autonomous vehicle is detected, a detection result showing the occurrence of the anomaly in the autonomous vehicle and predetermined map information showing the travel route from the origin up to the given time point and the estimated travel route.

In this way, it is possible to output information concerning the autonomous vehicle's travel route and information concerning the anomaly detection result.

Moreover, an anomaly detection method according to a fourth aspect is the anomaly detection method according to any one of the first to third aspects, in which the information regarding the plurality of routes is a travel route determination parameter, the travel route determination parameter is a parameter including a combination of values each indicating whether a corresponding one of events is present, the events being events that potentially affect determination of a travel route from the origin to the destination by the autonomous vehicle, and in the detection process, the estimated travel route is identified based on the travel route determination parameter.

In this way, as the information regarding the plurality of routes, it is possible to identify the estimated travel route based on whether each of events that may affect travel route determination by the autonomous vehicle is present.

Moreover, an anomaly detection method according to a fifth aspect is the anomaly detection method according to the fourth aspect, in which the information regarding the plurality of routes includes at least one of (i) a distance from the origin to the destination in each of the plurality of routes or (ii) a duration required for each of the plurality of routes of the autonomous vehicle from the origin to the destination.

In this way, as the information regarding the plurality of routes, it is possible to identify the estimated travel route based on information regarding the distance or the required duration.

Moreover, an anomaly detection method according to a sixth aspect is the anomaly detection method according to the fourth or fifth aspect, in which the information regarding the plurality of routes includes information indicating an event that potentially becomes an obstruction when the autonomous vehicle travels along each of the plurality of routes at the given time point.

In this way, it is possible to identify the estimated travel route based on information regarding events that may become obstructions to driving of the autonomous vehicle in each route.

Moreover, an anomaly detection method according to a seventh aspect is the anomaly detection method according to the sixth aspect, in which the information indicating the event that potentially becomes the obstruction when the autonomous vehicle travels along each of the plurality of routes includes information indicating whether each of the plurality of routes is traversable by the autonomous vehicle.

In this way, it is possible to identify the estimated travel route based on information indicating routes not traversable by the autonomous vehicle among the plurality of routes.

Moreover, an anomaly detection method according to an eighth aspect is the anomaly detection method according to any one of the fourth to seventh aspects, in which the autonomous vehicle is a vehicle used to transport cargo, the obtainment process further includes obtaining information regarding the cargo transported by the autonomous vehicle, the information regarding the cargo is the travel route determination parameter including at least one of (i) one or more information items each indicating an attribute of the cargo or (ii) one or more information items each indicating a transportation condition of the cargo, and in the detection process, the estimated travel route is identified based on the information regarding the plurality of routes and the information regarding the cargo.

In this way, when the autonomous vehicle is a vehicle used for transporting cargo, it is possible to identify the estimated travel route based on the cargo information in addition to the route information.

Moreover, an anomaly detection method according to a ninth aspect is the anomaly detection method according to any one of the fourth to eighth aspects, and further includes: a selection and readout process for selecting and reading out an anomaly detection model from among anomaly detection models corresponding to travel route determination parameters each of which is the travel route determination parameter. One of the plurality of routes is determined for each of the anomaly detection models, in the selection and readout process, an anomaly detection model corresponding to the travel route determination parameter is selected and read out, and in the detection process, a route determined for the anomaly detection model selected and read out is identified as the estimated travel route.

In this way, it is possible to identify, as the estimated travel route, the route specified by the anomaly detection model corresponding to the travel route determination parameter.

Moreover, an anomaly detection method according to a tenth aspect is the anomaly detection method according to the ninth aspect, in which the one of the plurality of routes determined for each of the anomaly detection models is updated to any one of the plurality of routes at predetermined intervals.

Moreover, an anomaly detection method according to an eleventh aspect is the anomaly detection method according to the tenth aspect, in which in each of the anomaly detection models, (i) the plurality of routes and (ii) a route weight of each of the plurality of routes that indicates a measure of probability of the autonomous vehicle traveling the route are specified, the route weight is updated at predetermined intervals, and based on the route weight of each of the plurality of routes, one of the plurality of routes is determined as an updated route in each of the anomaly detection models.

From these, it is possible to identify the route updated at predetermined intervals as the estimated travel route.

Moreover, an anomaly detection method according to a twelfth aspect is the anomaly detection method according to the tenth or eleventh aspect, and further includes: a training process for training each of the anomaly detection models. The training process includes the following performed at predetermined intervals: obtaining previously traveled routes that are travel routes in previous trips of the autonomous vehicle with a same combination of values of the travel route determination parameter, among previous trips of the autonomous vehicle from the origin to the destination; calculating, from the previously traveled routes obtained, a frequency at which the autonomous vehicle traveled along each of the plurality of routes; and determining, based on the frequency calculated, one of the plurality of routes as a route for an anomaly detection model corresponding to the travel route determination parameter.

Since it is possible to update the route specified by the anomaly detection model on the basis of the previous trips of the autonomous vehicle, it is possible to identify the estimated travel route reflecting the tendencies of travel routes selected in the past by the autonomous vehicle.

Moreover, an anomaly detection method according to a thirteenth aspect is the anomaly detection method according to any one of the ninth to twelfth aspects, in which each of the plurality of routes is constituted by a combination of one or more segments each connecting two locations out of given locations on the plurality of routes, in each of the anomaly detection models, a segment weight is determined per segment of the one or more segments, the segment weight indicating a measure of probability of the autonomous vehicle traveling each of the one or more segments, the detection process includes: calculating the degree of anomaly of the travel route from the origin up to the given time point, based on a ratio of (i) a cumulative sum of the segment weight determined per segment of the one or more segments included in the travel route from the origin up to the given time point to (ii) a cumulative sum of the segment weight determined per segment of the one or more segments included in the estimated travel route, and when the degree of anomaly calculated exceeds the predetermined threshold, the occurrence of the anomaly in the autonomous vehicle is detected.

In this way, it is possible to calculate the degree of anomaly of the travel route of the autonomous vehicle for each segment included in the travel route.

Moreover, an anomaly detection method according to a fourteenth aspect is the anomaly detection method according to the thirteenth aspect, in which the detection process includes: making a correction to decrease the degree of anomaly when an event that leads to the autonomous vehicle determining an unusual travel route different from normal is defined and when the travel route determination parameter is a parameter with a combination including a value indicating presence of the event, and when the degree of anomaly after the correction exceeds the predetermined threshold, the occurrence of the anomaly in the autonomous vehicle is detected.

Since it is possible to make a correction to lower the degree of anomaly when an unusual operation of the autonomous vehicle different from usual is performed, it is possible to suppress the occurrence of a false detection.

Moreover, an anomaly detection method according to a fifteenth aspect is the anomaly detection method according to any one of the ninth to fourteenth aspects, in which parameter groups are set to classify the travel route determination parameters, one or more travel route determination parameters each of which is the travel route determination parameter are determined for each of the parameter groups, the anomaly detection models correspond to the parameter groups, and the detection process includes: determining, from the parameter groups, a parameter group for which the travel route determination parameter is determined; selecting and reading out an anomaly detection model corresponding to the parameter group for which the travel route determination parameter is determined; and identifying, as the estimated travel route, a route specified by the anomaly detection model selected and read out.

In this way, it is possible to classify the travel route determination parameters into parameter groups, and identify, as the estimated travel route, the route specified by one anomaly detection model corresponding to each parameter group. Thus, it is possible to decrease the number of anomaly detection models to be prepared.

Moreover, an anomaly detection method according to a sixteenth aspect is the anomaly detection method according to the fifteenth aspect, in which in each of the parameter groups, an importance level representing a tendency of a value included in the combination across the one or more travel route determination parameters is determined, the importance level is constituted by a combination of values corresponding to the combination of the values indicated by the travel route determination parameter, and in the detection process, when none of the parameter groups specifies the travel route determination parameter, an anomaly detection model corresponding to a parameter group with the importance level most similar to the importance level of the travel route determination parameter among the parameter groups is selected and read out.

In this way, it is possible to determine the importance levels for each parameter group. Even when a combination of values of the travel route determination parameter is new, it is possible to classify the travel route determination parameter into a parameter group.

Moreover, an anomaly detection method according to a seventeenth aspect is the anomaly detection method according to the fifteenth or sixteenth aspect, and further includes: a training process for training each of the anomaly detection models. The training process includes: obtaining (i) the travel route determination parameters obtained in previous trips of the autonomous vehicle from the origin to the destination and (ii) previously traveled routes that are travel routes of the autonomous vehicle in the previous trips; and creating the parameter groups by grouping, as a same parameter group, the travel route determination parameters determined for one or more previous trips where the previously traveled routes are similar.

Regarding the previous trips, it is possible to classify, into the same parameter group, travel route determination parameters that led to similar travel routes. Thus, it is possible to more accurately classify travel route determination parameters into the parameter groups.

Moreover, an anomaly detection method according to an eighteenth aspect is the anomaly detection method according to the sixteenth aspect, and further includes: a training process for training each of the anomaly detection models. In the training process, in each of the parameter groups, in a case where the parameter group is characterized by a value indicating presence of one event among the events included in the one or more travel route determination parameters, a value of the importance level corresponding to the value indicating the presence of the one event is determined to be higher compared to an other case, and in a case where the parameter group is characterized by a value indicating absence of one event among the events included in the one or more travel route determination parameters, a value of the importance level corresponding to the value indicating the absence of the one event is determined to be lower compared to an other case.

Since it is possible to reflect, on the importance level, the characteristics or tendencies of each of one or more travel route determination parameters included in each parameter group, it is possible to more accurately classify the travel route determination parameters into the parameter groups.

Moreover, an anomaly detection method according to a nineteenth aspect is the anomaly detection method according to the seventeenth aspect, in which the training process further includes: creating the anomaly detection model by (i) calculating, using each of the previously traveled routes that are similar and correspond to one of the parameter groups created through grouping, a frequency at which the autonomous vehicle traveled along each of the plurality of routes, and (ii) determining a route weight of each of the plurality of routes based on the frequency calculated.

Since it is possible to create an anomaly detection model on the basis of the previous trips of the autonomous vehicle, it is possible to identify the estimated travel route reflecting past history information.

Moreover, an anomaly detection device according to a twentieth aspect of the present disclosure is an anomaly detection device that detects an anomaly in an autonomous vehicle that autonomously travels from an origin to a destination. The anomaly detection device includes: an obtainer that obtains a travel route along which the autonomous vehicle has traveled from the origin up to a given time point; a memory section that stores information regarding a plurality of routes traversable by the autonomous vehicle from the origin to the destination; and an anomaly detector that (i) identifies, based on the information regarding the plurality of routes read out from the memory section, one of the plurality of routes as an estimated travel route of the autonomous vehicle from the origin to the destination, (ii) calculates a degree of anomaly representing an extent to which the travel route up to the given time point deviates from the estimated travel route identified, and (iii) detects an occurrence of an anomaly in the autonomous vehicle when the degree of anomaly calculated exceeds a predetermined threshold.

Since the estimated travel route of the autonomous vehicle is identified, even if the position information regarding the autonomous vehicle has been manipulated or an unauthorized operation is performed on the autonomous vehicle, it is possible to detect an anomaly on the basis of the estimated travel route. That is, if the traveled route of the autonomous vehicle up to the given time point deviates from the identified estimated travel route, it is possible to detect an occurrence of an anomaly.

Moreover, a recording medium according to a twenty-first aspect of the present disclosure is a non-transitory computer-readable recording medium having recorded thereon a program for causing the computer to execute the anomaly detection method according to any one of the first to nineteenth aspects.

Since the estimated travel route of the autonomous vehicle is identified, even if the position information regarding the autonomous vehicle has been manipulated or an unauthorized operation is performed on the autonomous vehicle, it is possible to detect an anomaly on the basis of the estimated travel route. That is, if the traveled route of the autonomous vehicle up to the given time point deviates from the identified estimated travel route, it is possible to detect an occurrence of an anomaly.

Each of the embodiments described below shows a specific example of the present disclosure. The numerical values, shapes, constituent elements, arrangement of the constituent elements, steps, order of steps, and so forth indicated in the embodiments described below are merely examples, and do not intend to limit the present disclosure. Moreover, among the constituent elements described in the embodiments below, those not recited in any of the independent claims are described as optional constituent elements. Moreover, each embodiment may be combined in whole or in part.

### EMBODIMENT

Hereinafter, an anomaly detection device according to an embodiment is described.

In detecting an anomaly in a travel route, an anomaly detection device receives inputs including past and current travel status and travel route determination parameters as external factors, such as current weather and road traffic information, considered when determining a travel route, determines, using the inputs, whether the current travel location is abnormal due to an attacker or a system malfunction, and then presents the information to an operator.

### <Configuration of Anomaly Detection System>

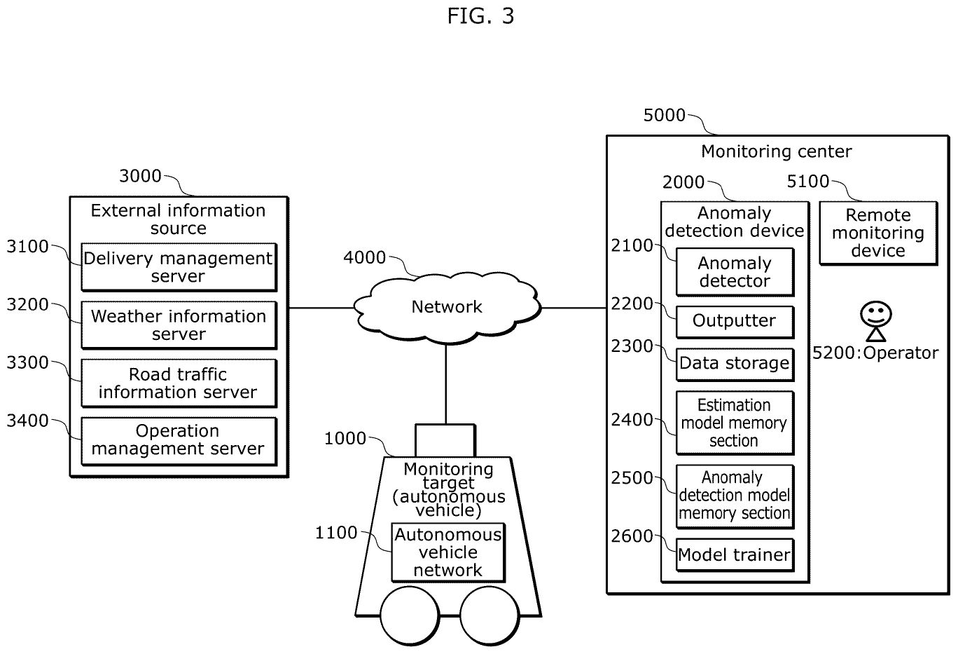

FIG. 3 illustrates a configuration of an anomaly detection system in the embodiment. In FIG. 3, the anomaly detection system includes monitoring target 1000 (autonomous vehicle), monitoring center 5000, external information source 3000, and network 4000.

Monitoring center 5000 has an on-premises analysis environment where anomaly detection device 2000 and remote monitoring device 5100 are provided. Monitoring center 5000 obtains, via network 4000, information exchanged over autonomous vehicle network 1100 within monitoring target 1000 located in a remote location, remotely monitors monitoring target 1000, performs anomaly detection analysis based on the obtained information, and stores the information. It should be noted that in monitoring center 5000, operator 5200 may be present who remotely monitors monitoring target 1000, and performs control for monitoring target 1000 according to the result of anomaly detection. Moreover, at least some elements of anomaly detection device 2000 and remote monitoring device 5100 included in monitoring center 5000 may exist in the cloud. Moreover, anomaly detection device 2000 may be external to monitoring center 5000.

Anomaly detection device 2000 obtains, via network 4000 and monitoring center 5000, travel-related information regarding monitoring target 1000 from autonomous vehicle network 1100 within monitoring target 1000 located in a remote location, performs anomaly detection analysis for the obtained information, and stores the information. It should be noted that anomaly detection device 2000 may obtain the travel-related information regarding monitoring target 1000 directly via network 4000 from monitoring target 1000.

Remote monitoring device 5100 obtains, via network 4000 and monitoring center 5000, the travel-related information regarding monitoring target 1000 exchanged over autonomous vehicle network 1100 within monitoring target 1000, and monitors the status of monitoring target 1000 on the basis of the obtained information. It should be noted that remote monitoring device 5100 may transmit control-related information regarding monitoring target 1000 to monitoring target 1000 via network 4000. That is, remote monitoring device 5100 may remotely control monitoring target 1000.

Monitoring target 1000 is an autonomous vehicle, such as a self-driving vehicle, a material-handling vehicle, a cleaning robot, or a security robot. First, monitoring target 1000 determines the travel route from the origin where monitoring target 1000 is located to the set destination, using, for example, map information for the target area and location, and autonomously travels along the set travel route. In the embodiment, monitoring target 1000 is treated as a material-handling vehicle that is an autonomous vehicle used in material-transport services in the embodiment.

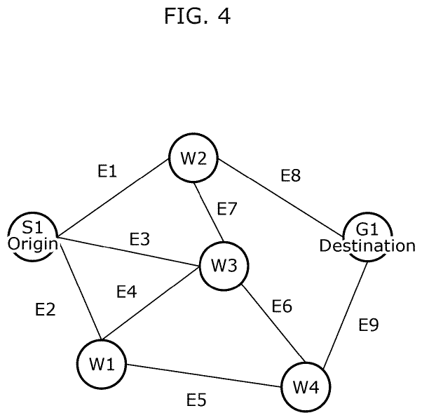

FIG. 4 illustrates an example in which map information used when monitoring target 1000 determines the travel route is presented in graphical form. In FIG. 4, for ease of handling of the map information in anomaly detection device 2000, the map information is shown using circular nodes and solid-line edges. In FIG. 4, a circular node labeled S1 indicates the origin of monitoring target 1000, a circular node labeled G1 indicates the destination of monitoring target 1000, and circular nodes labeled W1 to W4 indicate intermediate points corresponding to respective locations preset in the map information. The intermediate points are set on, for example, intersections on the map information and set on any locations on the map accessible by the autonomous vehicle. It should be noted that each of the origin and the destination may be one of the intermediate points or, for example, a location at any address that is a location different from the intermediate points. Moreover, two or more destinations may be set instead of just one. Furthermore, solid-line edges labeled E1 to E9 indicate segments. Each segment is a route actually traversable by monitoring target 1000 among routes connecting pairs of points: the intermediate points, the origin, and the destination. It should be noted that each edge is not limited to a straight line, and a curved line may be included to match the actual map information. Moreover, in the embodiment, the number of edges between the nodes is less than one. That is, each pair of points: the intermediate points, the origin, and the destination is connected by a single route.

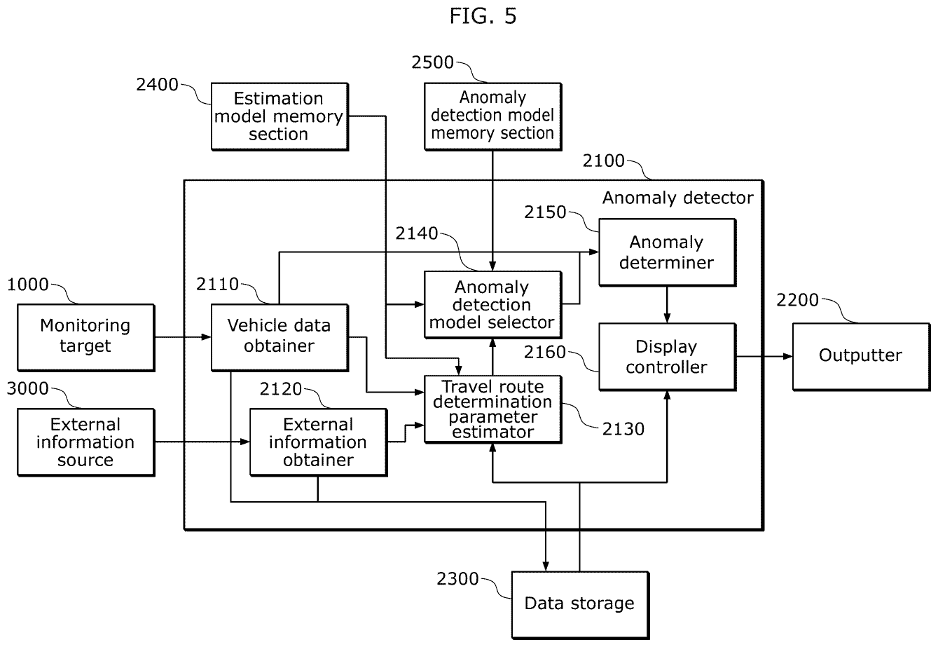

In FIG. 4, monitoring target 1000 determines the travel route, which starts from origin S1, follows route E1, passes intermediate point W2, continues along route E8, and arrives at destination G1, for example. Monitoring target 1000 then autonomously follows the route. It should be noted that in FIG. 4, the intermediate points, the origin, and the destination are represented by circular nodes, and each route is represented by a solid line. However, the map information used when monitoring target 1000 determines the travel route is not limited to the above, and the map information may be shown by another representation method, and the map information may be an actual map or an aerial photograph. Moreover, the map information may also include the distance of each route and the average travel time required for each route of monitoring target 1000. Map information used in the following embodiment is the map information illustrated in FIG. 4. Locations and routes in the embodiment are described as the locations and routes included in the map information in FIG. 4. Moreover, although the map information illustrated in FIG. 4 is stored in data storage 2300, external information obtainer 2120 (described in FIG. 5) may obtain the map information from external information source 3000.

Monitoring target 1000 includes autonomous vehicle network 1100, and transmits travel-related information regarding monitoring target 1000 exchanged over autonomous vehicle network 1100 to anomaly detection device 2000 via network 4000. It should be noted that monitoring target 1000 is not limited to one autonomous vehicle, and there may be two or more monitoring targets 1000 that are autonomous vehicles. When there are two or more monitoring targets 1000, each autonomous vehicle transmits its autonomous vehicle information to anomaly detection device 2000 via network 4000.

Network 4000 uses, for example, virtual private network (VPN) communication over a standard internet connection to securely transmit information regarding monitoring target 1000 to anomaly detection device 2000. It should be noted that network 4000 may be constituted by networks.

External information source 3000 provides, via network 4000, anomaly detection device 2000 with various vehicle travel-related information items, such as weather information, shipment information, and road traffic information. External information source 3000 includes servers such as weather information server 3200 of an external service that handles weather information, road traffic information server 3300 of an external service that handles road traffic information, delivery management server 3100 that manages information regarding cargo transported by a material-handling vehicle, and operation management server 3400 that manages operation of an autonomous vehicle. It should be noted that external information source 3000 may include a server and an information source that manage or provide other information, depending on the usage types and service formats of an autonomous vehicle. For instance, when monitoring target 1000 is a security robot for guarding a predetermined facility or site, external information source 3000 may include a server that manages or provides information regarding the facility, information regarding the crowd density, and so forth.

### <Configurations of Elements of Anomaly Detection Device 2000>

Anomaly detection device 2000 includes anomaly detector 2100, outputter 2200, data storage 2300, estimation model memory section 2400, anomaly detection model memory section 2500, and model trainer 2600.

Anomaly detector 2100 performs anomaly detection on the basis of the information obtained from monitoring target 1000.

Outputter 2200 includes a displaying part such as a user interface (UI), and presents, to operator 5200, information visualized by mapping the result of anomaly detection by anomaly detector 2100 onto map information or the like. It should be noted that when an anomaly is detected in the travel route of monitoring target 1000, outputter 2200 may output an instruction to control monitoring target 1000 or a notification to remote monitoring device 5100. For instance, outputter 2200 may output, to remote monitoring device 5100, a control instruction to bring monitoring target 1000 to an emergency stop. It should be noted that in the embodiment, outputter 2200 corresponds to a display.

Data storage 2300 stores and accumulates travel-related data for monitoring target 1000 obtained by anomaly detector 2100. It should be noted that data storage 2300 may store map information and information concerning travel route determination for monitoring target 1000, which includes information regarding the status of each route in the map information, obtained by anomaly detector 2100. It should be noted that in the embodiment, data storage 2300 corresponds to a memory section.

Estimation model memory section 2400 stores an estimation model and parameter information that defines the types of travel route determination parameters constituting a combination of travel route determination parameters included in each travel route determination parameter group within the estimation model. The estimation model, travel route determination parameter groups, and travel route determination parameters are described later.

Anomaly detection model memory section 2500 stores anomaly detection models corresponding to the travel route determination parameter groups. The anomaly detection models are described later. It should be noted that in the embodiment, estimation model memory section 2400 and anomaly detection model memory section 2500 also correspond to the memory section.

Model trainer 2600 performs a model training process on the basis of the travel-related data for monitoring target 1000, which is stored in data storage 2300, and trains an estimation model and an anomaly detection model. A configuration of model trainer 2600 and the model training process are described later.

### <Configuration of Anomaly Detector 2100>

FIG. 5 illustrates a configuration of anomaly detector 2100 included in anomaly detection device 2000 according to the embodiment. In FIG. 5, anomaly detector 2100 includes vehicle data obtainer 2110, external information obtainer 2120, travel route determination parameter estimator 2130, anomaly detection model selector 2140, anomaly determiner 2150, and display controller 2160.

Vehicle data obtainer 2110 receives vehicle information regarding the current drive of monitoring target 1000 from monitoring target 1000 via network 4000. The vehicle information is information generated on the basis of a vehicle control signal that is a signal exchanged over autonomous vehicle network 1100 of monitoring target 1000. Moreover, the vehicle control signal mentioned here indicates a signal used to control vehicle operations or behaviors such as engine operation, braking, acceleration, and steering. Moreover, the received vehicle information is transmitted to data storage 2300, which then stores the vehicle information.

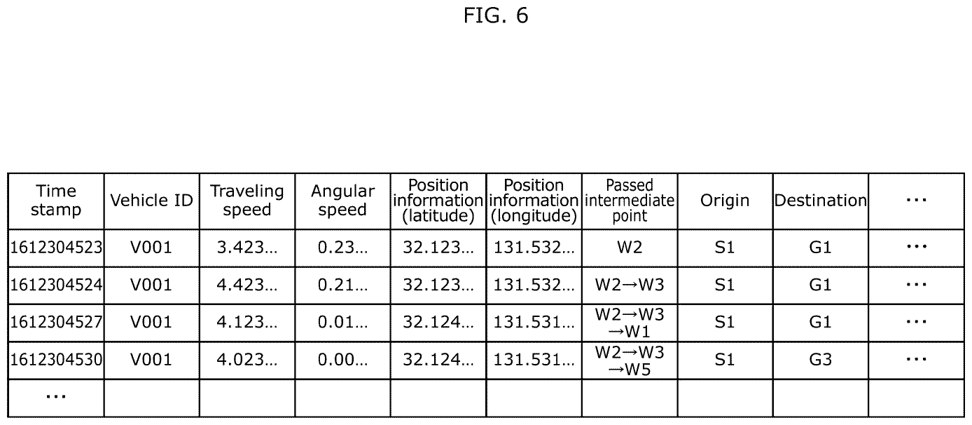

FIG. 6 illustrates an example of a data structure of vehicle information regarding monitoring target 1000 received by vehicle data obtainer 2110.

As illustrated in FIG. 6, the generated vehicle information includes a time stamp indicating a date and time, vehicle ID that is the identifier of monitoring target 1000, a traveling speed and an angular speed that are information indicating the driving status of monitoring target 1000, position information regarding monitoring target 1000, passed intermediate points indicating the intermediate points that monitoring target 1000 has passed so far on its way to the destination, and the origin and destination of monitoring target 1000. For instance, for monitoring target 1000 with vehicle ID V001, it is indicated that the origin is S1 and the destination is G1. It is indicated that at the date and time indicated by time stamp 1612304523, monitoring target 1000 traveled at a traveling speed of “3.423 . . . ” and an angular speed of “0.23 . . . ” at the location with a latitude of “32.123 . . . ” and a longitude of “131.532 . . . ”, and that monitoring target 1000 passed intermediate point W2 during the travel. It should be noted that the vehicle information is not limited to the information shown in FIG. 6, and may include other information. For instance, as information concerning device operation while driving, the vehicle information may include, for example, usage information for turn signals and hazard lights.

It should be noted that vehicle data obtainer 2110 may receive a vehicle control signal from monitoring target 1000, and generate travel-related vehicle information by analyzing the received vehicle control signal. That is, vehicle data obtainer 2110 receives the vehicle control signal in data format with a protocol such as controller area network (CAN) or FlexRay, or in ROS format, and generates vehicle information through analysis and data processing. It should be noted that the vehicle information in this case is generated every time vehicle data obtainer 2110 receives and analyzes the vehicle control signal.

External information obtainer 2120 obtains external information concerning travel route determination from external information source 3000. Examples of the external information include cargo information, weather information, information concerning the status of each route in map information, such as a road traffic information, and operation management information for the autonomous vehicle. The received external information is transmitted to and stored in data storage 2300. Moreover, in the embodiment, vehicle data obtainer 2110 and external information obtainer 2120 correspond to an obtainer.

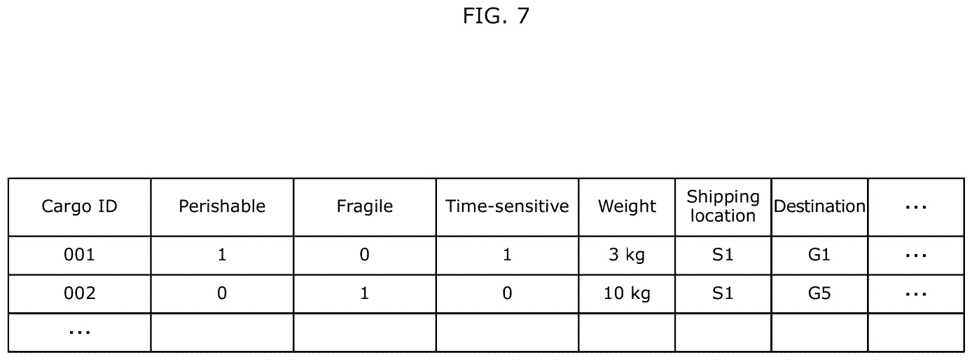

FIGS. 7 to 9 each illustrate an example of external information concerning travel route determination that external information obtainer 2120 obtains from external information source 3000.

FIG. 7 illustrates an example of information concerning cargo transported by monitoring target 1000, which is obtained by external information obtainer 2120 when monitoring target 1000 is a material-handling autonomous vehicle. A system or the like in, for example, a material-handling service provider or a shipping location of cargo stores cargo information in delivery management server 3100 that is an element of external information source 3000. External information obtainer 2120 obtains the cargo information from delivery management server 3100.

In the example illustrated in FIG. 7, the cargo information includes cargo ID that is an identifier assigned to each cargo item, information indicating whether the cargo is perishable or fragile, as the type of cargo and a transportation condition, information indicating whether the transportation condition is time-sensitive, and information such as the weight, the shipping location, and the delivery destination of the cargo. The category of perishable, the category of fragile, and the category of time-sensitive can take a value of 0 or 1. That is, when the cargo is perishable, the category of perishable takes a value of 1, and when the cargo is fragile, the category of fragile takes a value of 1. Otherwise, the categories of perishable and fragile take a value of 0. When the transportation condition is time-sensitive, the category of time-sensitive takes a value of 1. When the transportation condition of time-sensitive is not specified, the category of time-sensitive takes a value of 0. In FIG. 7, for example, regarding the cargo with cargo ID 001, the type of cargo is perishable, the transportation condition of time-sensitive is specified, the weight is 3 kg, the shipping location is location S1, and the intended destination for delivery is location G1. It should be noted that the cargo information is not limited to the information illustrated in FIG. 7, and may include other information. For instance, the types of cargo may include information indicating that the cargo item is moisture-sensitive, information indicating that the cargo is chilled, and information indicating that the cargo is frozen. Moreover, a designated delivery time may be set as a transportation condition.

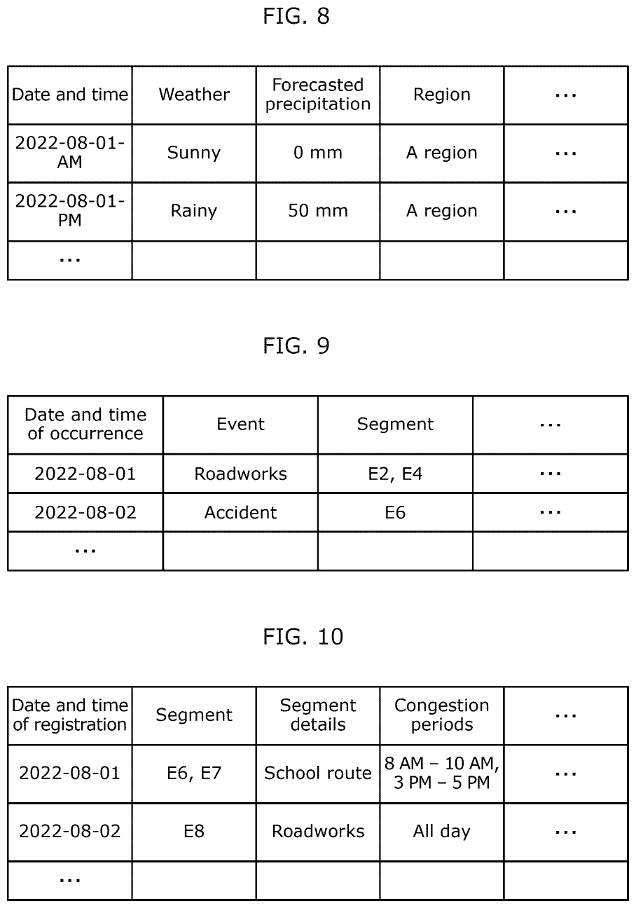

FIG. 8 illustrates an example of weather information obtained by external information obtainer 2120. External information obtainer 2120 is, for example, an element of external information source 3000, and obtains weather information from weather information server 3200 of an external service that provides weather information.

In the example illustrated in FIG. 8, the weather information is information based on a weather forecast, and includes a date and time, weather, forecasted precipitation, and regional information. FIG. 8 shows that, for instance, in A region, the weather forecast for 2022-08-01-AM (date and time) is sunny, with forecasted precipitation of 0 mm. It should be noted that external information obtainer 2120 typically obtains weather information for the region where monitoring target 1000 is located. However, external information obtainer 2120 may simultaneously obtain weather information for the areas surrounding the region where monitoring target 1000 is located, for example. The weather information is not limited to the information illustrated in FIG. 8, and may include other information. For instance, based on the weather forecast, the weather information may include details such as wind speed, snowfall, temperature, and humidity.

FIG. 9 illustrates an example of road traffic information obtained by external information obtainer 2120. External information obtainer 2120 is, for example, an element of external information source 3000, and obtains road traffic information from road traffic information server 3300 of an external service that provides road traffic information.

In the example illustrated in FIG. 9, the road traffic information includes an event occurring on the road that affects traffic conditions, the date and time of the event, and the location or segment where the event is occurring. FIG. 9 shows that, for example, roadwork (event) has been underway in segments E2 and E4 since 2022-08-01 (date and time). External information obtainer 2120 typically obtains road traffic information for segments traversable by monitoring target 1000, but external information obtainer 2120 may also simultaneously obtain road traffic information for other surrounding segments. It should be noted that road traffic information typically includes only information regarding ongoing events and does not include information regarding resolved events. However, the road traffic information may include details on all events that have occurred. Moreover, the road traffic information may also include information indicating whether a segment where an event is occurring is traversable, information indicating the duration of the event, or information regarding the location of the event.

FIG. 10 illustrates an example of operation management information for managing the daily operation status of an autonomous vehicle, which is obtained by external information obtainer 2120. The operation management information is stored in operation management server 3400 that is an element of external information source 3000 and is operated by, for example, operator 5200 or a service provider that performs remote monitoring and anomaly detection for autonomous vehicles. External information obtainer 2120 obtains the operation management information from operation management server 3400.

In the example illustrated in FIG. 10, the operation management information includes (i) information regarding a segment registered by operator 5200 or a service provider that performs remote monitoring and anomaly detection for monitoring target 1000, as a segment with an event that may obstruct travel of monitoring target 1000, (ii) the date and time of registration of the segment, (iii) segment details indicating the type of the event occurring in the registered segment, and (iv) information regarding a time period during which congestion may occur in the segment due to the event. FIG. 10 shows that, for example, segments E6 and E7 were registered as school routes (segment details) on 2022-08-01 (date and time), and that congestion periods in the segments are from 8 am to 10 am and from 3 pm to 5 pm. It should be noted that the operation management information is not limited to the information illustrated in FIG. 10, and may include other information. For instance, the operation management information may include route information regarding the characteristics of segments traversable by monitoring target 1000, information regarding near-miss locations or the like, and information indicating segment registration or the event duration. Moreover, the operation management information may include information indicating whether each segment is traversable in a specific time period.

Moreover, external information obtainer 2120 may obtain, from external information source 3000, for example, map information as shown in FIG. 4 and information such as the distance of each route in the map information and the average travel time for each route of monitoring target 1000. Moreover, the external information may be directly obtained in format of combinations of travel route determination parameters, which are described later.

The above is an example of the external information concerning travel route determination when monitoring target 1000 in the embodiment is a material-handling vehicle. However, when monitoring target 1000 is an autonomous vehicle used in services other than material-handling vehicle services, external information concerning travel route determination may be different from the above. For instance, when monitoring target 1000 is a security robot for guarding a designated facility or location, the external information does not include cargo information and may include (i) information about the level of a visiting dignitary and a room to be used, for determining a priority patrol route or (ii) information such as crowd density linked with an indoor local positioning system (LPS) or the like. In this way, the external information concerning travel route determination may change depending on the intended use of monitoring target 1000.

The description now returns to the configuration of anomaly detector 2100.

Travel route determination parameter estimator 2130 obtains the vehicle information regarding monitoring target 1000 from vehicle data obtainer 2110, and obtains various external information items concerning travel route determination from external information obtainer 2120. Furthermore, travel route determination parameter estimator 2130 obtains, from estimation model memory section 2400, grouping information for combinations of travel route determination parameters concerning travel route determination. Then, on the basis of the obtained vehicle information and various external information items, travel route determination parameter estimator 2130 determines a combination of travel route determination parameters for the current trip of monitoring target 1000. The travel route determination parameters and the combinations thereof are described later. In the embodiment, the current trip is described as representing a sequence of drives from the preset origin to all preset destinations.

Anomaly detection model selector 2140 obtains, from travel route determination parameter estimator 2130, the determined combination of the travel route determination parameters that affects the determination of the current travel route. Moreover, anomaly detection model selector 2140 obtains an estimation model from estimation model memory section 2400. Then, on the basis of the combination of the travel route determination parameters, anomaly detection model selector 2140 performs an anomaly detection model selection process, which is described later, selects an appropriate anomaly detection model for anomaly detection in the current travel route, and obtains the anomaly detection model from anomaly detection model memory section 2500.

Using the anomaly detection model selected and obtained by anomaly detection model selector 2140, anomaly determiner 2150 performs an anomaly determination process on the current vehicle information regarding monitoring target 1000 obtained by vehicle data obtainer 2110. In the anomaly determination process, anomaly determination is performed by comparing the current trip and a travel route with high usage frequency linked with the combination of the travel route determination parameters included in the anomaly detection model, that is, information regarding an estimated travel route. Details of the anomaly determination process are described later.

When the result of the anomaly determination process of anomaly determiner 2150 shows that an anomaly is present, display controller 2160 transmits the determination result to outputter 2200 to cause outputter 2200 to display the determination result, in order to inform operator 5200 that monitoring target 1000 may be following an unusual route. Map information may be transmitted together with the determination result.

### <Operation of Anomaly Detection Process>

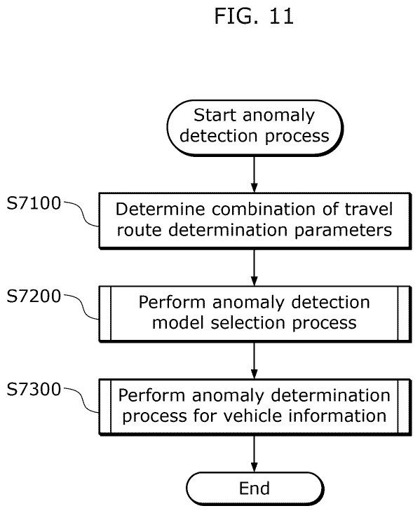

Next, an anomaly detection process performed by anomaly detection device 2000 is described. FIG. 11 is a flowchart illustrating an example of operation of an anomaly detection process in the embodiment.

In the anomaly detection process, first, travel route determination parameter estimator 2130 obtains vehicle information regarding monitoring target 1000 from vehicle data obtainer 2110 and various external information items concerning travel route determination from external information obtainer 2120. Moreover, travel route determination parameter estimator 2130 obtains parameter information from estimation model memory section 2400. The parameter information is information that defines the types of travel route determination parameters included in a combination of travel route determination parameters. On the basis of the obtained parameter information, by referring to the vehicle information and the various external information items, travel route determination parameter estimator 2130 determines a combination of travel route determination parameters for the current trip of monitoring target 1000 subject to anomaly detection (S7100).

Here, the various external information items indicate elements that may affect travel route determination for monitoring target 1000. Each travel route determination parameter is an index indicating whether a corresponding one of the elements is present, and may take a value of 0 or 1. A value of 0 indicates absence of the element, and a value of 1 indicates presence of the element. The elements that may affect travel route determination for monitoring target 1000 are, for example, that the cargo of monitoring target 1000 is fragile, that the weather is rainy, and that traffic congestion is expected in the segment.

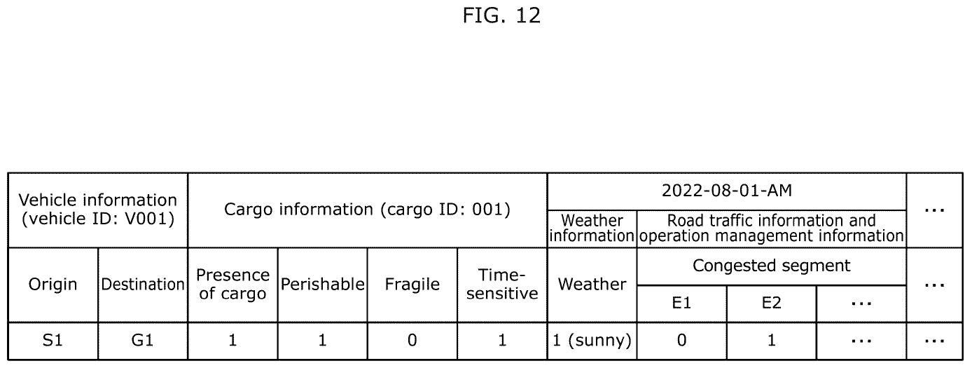

Moreover, a combination of travel route determination parameters includes a combination of travel route determination parameters and information about the origin and destination included in the vehicle information regarding monitoring target 1000. FIG. 12 illustrates an example of the combination of the travel route determination parameters determined by travel route determination parameter estimator 2130 in step S7100.

FIG. 12 illustrates a combination of travel route determination parameters when monitoring target 1000 with vehicle ID V001 illustrated in FIG. 6 transports cargo with cargo ID 001 illustrated in FIG. 7 at the date and time of 2022-08-01-AM. It should be noted that in the example illustrated in FIG. 12, the shipping location of the cargo is the origin of monitoring target 1000, and the destination of the cargo is the destination of monitoring target 1000. Here, the information that monitoring target 1000 with vehicle ID V001 transports the cargo with cargo ID 001 is input into external information source 3000 or monitoring target 1000 by, for example, operator 5200 or a service provider that loads the cargo onto monitoring target 1000. Travel route determination parameter estimator 2130 determines a combination of travel route determination parameters on the basis of cargo information linked with each monitoring target 1000.

In FIG. 12, the combination of the travel route determination parameters is constituted by travel route determination parameters assigned on the basis of respective details of the vehicle information, cargo information, weather information, road traffic information, and operation management information. As for the vehicle information, the origin and destination of monitoring target 1000 with vehicle ID V001 illustrated in FIG. 6 are shown. As for the cargo information, the values of the categories of perishable, fragile, and time-sensitive with regard to the cargo with cargo ID 001 illustrated in FIG. 7 are shown as travel route determination parameters. Moreover, regarding the category of presence of cargo, a value indicating whether monitoring target 1000 is transporting the cargo is shown as a travel route determination parameter. Here, when monitoring target 1000 is transporting the cargo, the travel route determination parameter corresponding to the category of presence of cargo is 1. When monitoring target 1000 is not transporting the cargo, the travel route determination parameter corresponding to the category of presence of cargo is 0. For instance, when returning after delivering the cargo or moving from a garage to a pickup point (shipping location), cargo is not loaded onto monitoring target 1000. Thus, the travel route determination parameter is 0. As for the weather information, weather corresponding to the time when monitoring target 1000 is expected to travel, which is illustrated in FIG. 8 is shown as a travel route determination parameter. Here, the travel route determination parameter for the sunny weather is 1. As for the road traffic information and the operation management information, information indicating, according to the information regarding each segment illustrated in FIGS. 9 and 10, whether congestion is expected in the segment is shown as a travel route determination parameter. Here, for the date and time when monitoring target 1000 is expected to travel each route, when the route is a congested segment, the travel route determination parameter is 1, and when the route is not a congested segment, the travel route determination parameter is 0. It should be noted that a method for determining travel route determination parameters and combinations of travel route determination parameters are not limited to the above. For instance, a parameter indicating a segment temporally not traversable by monitoring target 1000, a parameter indicating that the segment is a school route, a parameter based on the precipitation, and so forth may be included. Moreover, when a combination of travel route determination parameters is obtained as the external information, external information obtainer 2120 determines the obtained combination of the travel route determination parameter as a combination of travel route determination parameters for the current trip of monitoring target 1000.

Next, with reference to FIG. 11 again, anomaly detection model selector 2140 obtains the combination of the travel route determination parameters determined by travel route determination parameter estimator 2130 in step S7100. Moreover, anomaly detection model selector 2140 obtains an estimation model from estimation model memory section 2400. Then, anomaly detection model selector 2140 performs the anomaly detection model selection process, selects, from the estimation model, a travel route determination parameter group corresponding to the combination of the travel route determination parameters determined in step S7100, and obtains an anomaly detection model corresponding to the selected travel route determination parameter group from anomaly detection model memory section 2500 (S7200).

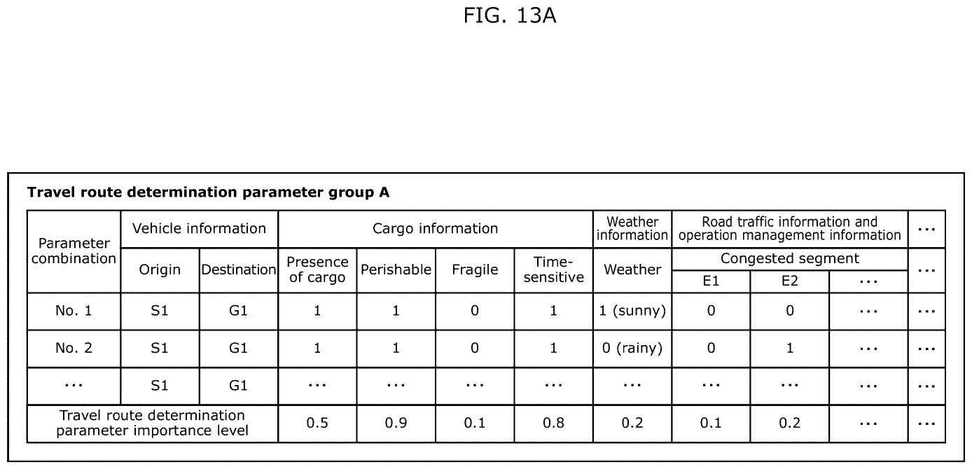

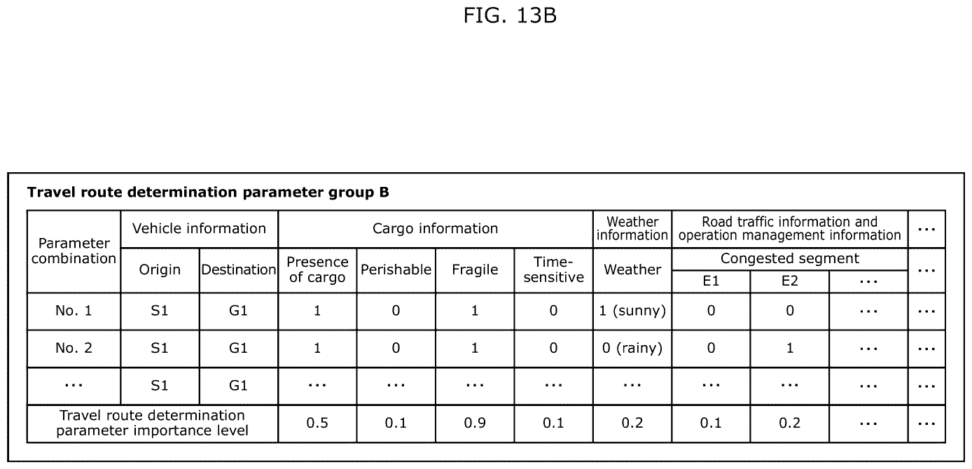

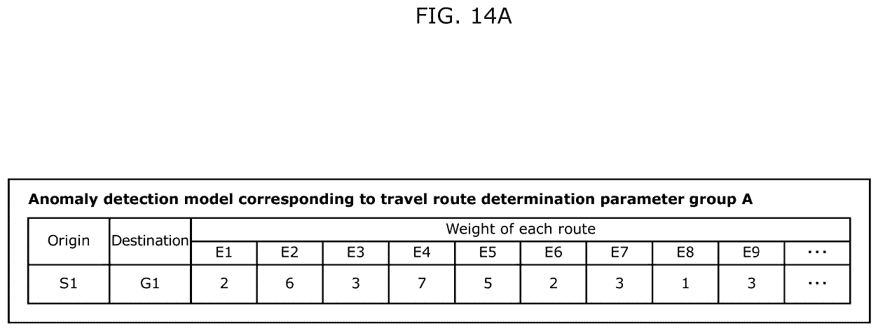

Here, the estimation model stored in estimation model memory section 2400 is described. FIGS. 13A and 13B illustrate an example of an estimation model. In FIGS. 13A and 13B, an estimation model includes travel route determination parameter groups such as travel route determination parameter group A (FIG. 13A) and travel route determination parameter group B (FIG. 13B). Moreover, the estimation model includes the third and subsequent travel route determination parameter groups such as travel route determination parameter group C (not illustrated). One travel route determination parameter group includes one or more combinations of travel route determination parameters and the importance level of each travel route determination parameter.

Regarding the one or more combinations of travel route determination parameters included in the one travel route determination parameter group, although at least the same combination of origin and destination is used, travel route determination parameters combined are different. Each combination of travel route determination parameters is grouped into one of the travel route determination parameter groups by performing a travel route determination parameter grouping process, which is described later. When monitoring target 1000 determines the respective travel routes on the basis of combinations of travel route determination parameters grouped into the same travel route determination parameter group, the determined travel routes are similar. FIGS. 13A and 13B each illustrate a portion of the travel route determination parameter group with origin S1 and destination G1. However, the estimation model may include a travel route determination parameter group with a different origin or a different destination.

The importance level of each travel route determination parameter is the magnitude of the effect that the travel route determination parameter has on travel route determination by monitoring target 1000. This indicates that a travel route determination parameter with a high importance level has a large effect on the travel route determination in the group. A parameter importance calculation process that determines the importance level is described later. The importance level of a travel route determination parameter with a high frequency of 1 across the combinations within the same group is calculated to be higher. In addition, the importance level of a travel route determination parameter with a high frequency of 1 in other groups is calculated to be lower than that of a travel route determination parameter with a low frequency of 1 in the other groups. In other words, the importance level of the travel route determination parameter with a low frequency of 1 in the other groups is calculated to be higher than that of the travel route determination parameter with a high frequency of 1 in the other groups. In travel route determination parameter group A in FIG. 13A, the importance level of “presence of cargo” (travel route determination parameter) is 0.5, the importance level of “perishable” (travel route determination parameter) is 0.9, and the importance level of “time-sensitive” (travel route determination parameter) is 0.8. The three travel route determination parameters are assigned higher importance levels than the other travel route determination parameters within the group. This is because the above travel route determination parameters often take a value of 1 within the group. Moreover, among the parameters, the travel route determination parameters: “perishable” and “time-sensitive” have a low frequency of 1 in the other groups. Thus, the importance levels of the parameters are higher than the importance level of “presence of cargo”. In other words, the importance level of each parameter within the group is a representative value that reflects the tendency or characteristic of its combinability in the combinations of travel route determination parameters included in the travel route determination parameter group.

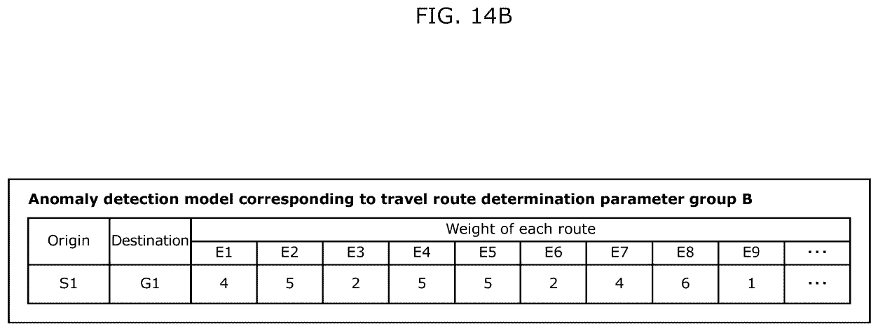

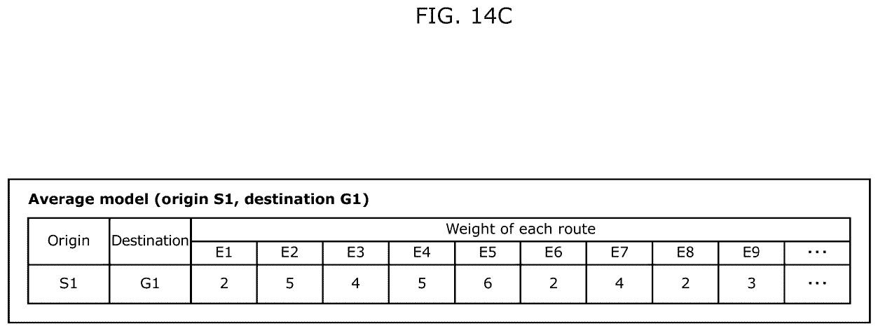

Moreover, anomaly detection models stored in anomaly detection model memory section 2500 are described. FIGS. 14A to 14C illustrate examples of anomaly detection models. In FIGS. 14A to 14C, one anomaly detection model is associated with each of travel route determination parameter groups. Each anomaly detection model includes the origin, the destination, and the weight of each route. The weight of each route is a measure based on the probability that the route will be selected when monitoring target 1000 determines the travel route on the basis of each combination of travel route determination parameters within a group. A small weight is assigned to a route with high probability of selection, and a large weight is assigned to a route with low probability of selection.

The weight of each route is determined by performing an anomaly detection model training process, which is described later. In FIG. 14A, in the anomaly detection model corresponding to travel route determination parameter group A, route E1 has a weight of 2, and route E2 has a weight of 6. This indicates that route E1 is more likely to be selected than route E2 in the travel route determination.

Moreover, the anomaly detection model includes an average model for each combination of origin and destination. The average model is the average anomaly detection model of all anomaly detection models associated with all travel route determination parameter groups with the same combination of origin and destination. FIG. 14C illustrates the average model of all anomaly detection models with origin S1 and destination G1.

Then, the anomaly detection model selection process is described.

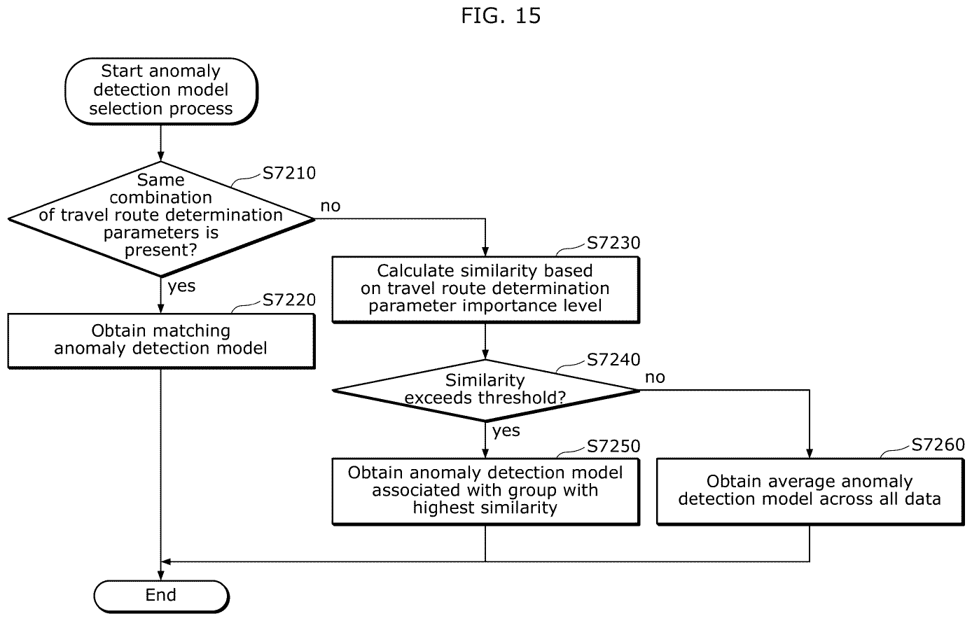

The anomaly detection model selection process is a process performed by anomaly detection model selector 2140, and a process that selects, from among the anomaly detection models stored in anomaly detection model memory section 2500, an anomaly detection model suitable for the combination of the travel route determination parameters determined by travel route determination parameter estimator 2130, that is, a combination of travel route determination parameters related to route determination in the current trip. FIG. 15 is a flowchart illustrating an example of operation of the anomaly detection model selection process.

First, the anomaly detection model selection process determines whether any one of travel route determination parameter groups included in the estimation model stored in estimation model memory section 2400 includes a combination of travel route determination parameters that is the same as the current combination of travel route determination parameters (S7210). For instance, in the embodiment, when the current combination of the travel route determination parameters is the combination illustrated in FIG. 12, whether the combination is present in any one of the travel route determination parameter groups is determined. When it is determined that the same combination is present (Yes in step S7210), the procedure proceeds to step S7220. When it is determined that the same combination is not present (No in step S7210), the procedure proceeds to step S7230.

Anomaly detection model selector 2140 obtains, from anomaly detection model memory section 2500, an anomaly detection model associated with a travel route determination parameter group including the combination of the travel route determination parameters that is the same as the current combination of the travel route determination parameters (S7220). Then, the anomaly detection model selection process ends.

Alternatively, to determine which travel route determination parameter group has similar characteristics to the current combination of the travel route determination parameters, anomaly detection model selector 2140 determines the degree of similarity between (i) the current combination of the travel route determination parameters and (ii) the importance level of each travel route determination parameter of each travel route determination parameter group included in the estimation model (S7230). It should be noted that the degree of similarity with a travel route determination parameter group that has the same combination of origin and destination as the current combination of the travel route determination parameters is determined. A method using, for example, cosine similarity is used as a similarity degree determination method. In the following description about the similarity degree determination method, for simplicity, the degree of similarity between group A and group B is determined using only (i) a combination of the four travel route determination parameters: “presence of cargo”, “perishable”, “fragile”, and “time-sensitive” and (ii) the importance level of each travel route determination parameter. However, in reality, the degree of similarity between all pairs of groups is calculated on the basis of combinations of all travel route determination parameters and the importance of each travel route determination parameter.

For instance, in FIGS. 13A and 13B, the four travel route determination parameters: “presence of cargo”, “perishable”, “fragile”, and “time-sensitive” in travel route determination parameter group A have importance levels of [0.5, 0.9, 0.1, and 0.8], respectively, and the four travel route determination parameters in travel route determination parameter group B have importance levels of [0.5, 0.1, 0.9, and 0.1], respectively.

In this case, as illustrated in FIG. 12, when the current combination of the four travel route determination parameters indicates [1, 1, 0, 1], if the degree of similarity between the current combination of the travel route determination parameters and each of group A and group B is determined using cosine similarity, the following result is obtained: the degree of similarity with group A: 0.97>the degree of similarity with group B: 0.39. Thus, in the above example, it is possible to determine that the current combination of the travel route determination parameters is more similar to travel route determination parameter group A with a higher degree of similarity.

Then, determination is performed to identify whether any degree of similarity to the travel route determination parameter groups with the same combination of origin and destination, calculated in step S7230 exceeds a preset threshold (S7240). When it is determined that any of degrees of similarity exceeds the threshold (Yes in step S7240), the procedure proceeds to step S7250. When it is determined that none of the degrees of similarity exceeds the threshold (No in step S7240), the procedure proceeds to step S7260. The threshold is set to any value between 0 and 1 (inclusive), and for example, the threshold is 0.7. The threshold is determined by, for example, operator 5200.

Anomaly detection model selector 2140 obtains, from anomaly detection model memory section 2500, an anomaly detection model associated with a travel route determination parameter group most similar to the current combination of the travel route determination parameters (S7250). For instance, when the degree of similarity with group A is the highest, anomaly detection model selector 2140 obtains an anomaly detection model associated with group A. Then, the anomaly detection model selection process ends.

Alternatively, if no group with a similarity exceeding the threshold is found for the current combination of the travel route determination parameters, in the travel route determination parameter groups stored in anomaly detection model memory section 2500, anomaly detection model selector 2140 obtains, from anomaly detection model memory section 2500, an average model corresponding to the combination of origin and destination included in the current combination of the travel route determination parameters (S7260). Then, the anomaly detection model selection process ends.

The description now returns to the anomaly detection process.

Using the anomaly detection model selected and obtained by anomaly detection model selector 2140, anomaly determiner 2150 performs the anomaly determination process for the current vehicle information regarding monitoring target 1000 obtained by vehicle data obtainer 2110 (S7300). Furthermore, the result of anomaly determination and map information are transmitted to outputter 2200 via display controller 2160 to cause outputter 2200 to output the data. Then, the anomaly detection process ends.

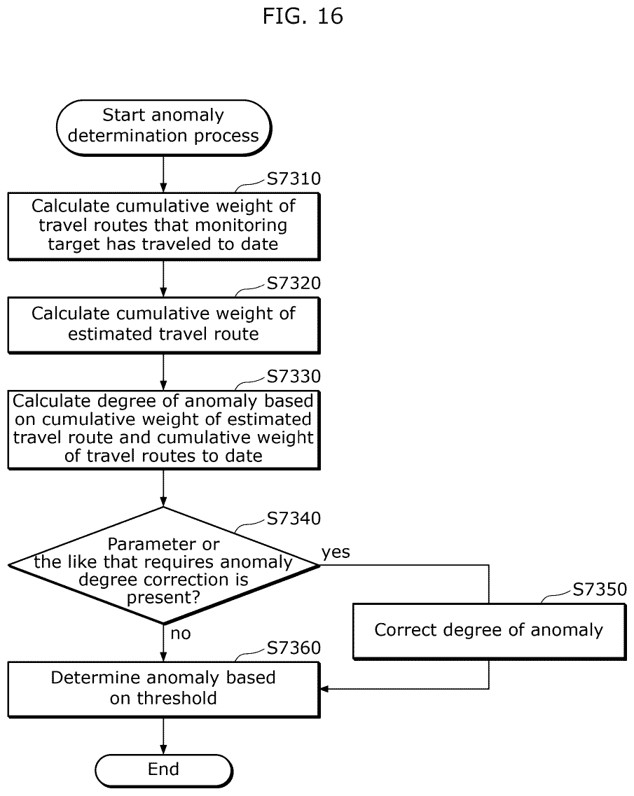

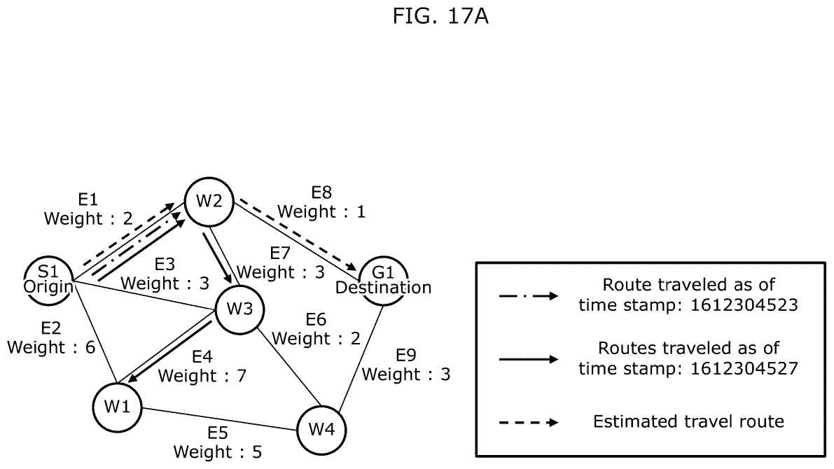

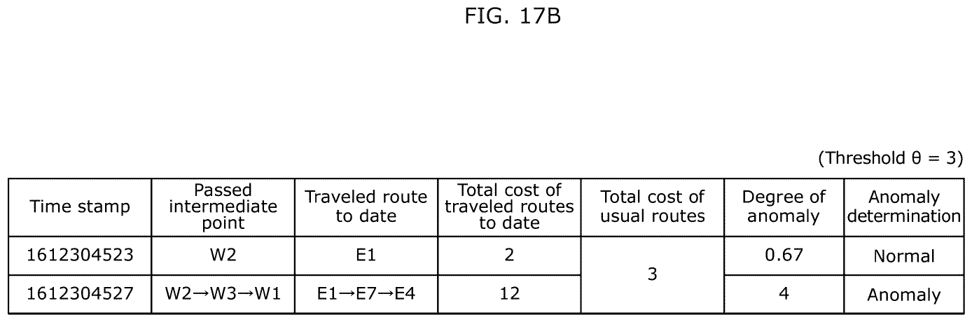

The anomaly determination process is described. The anomaly determination process is a process performed by anomaly determiner 2150, and a process that determines the anomaly (degree of anomaly) for the current trip of monitoring target 1000 on the basis of the weight of each route included in the anomaly detection model. In the embodiment, for instance, the anomaly detection model obtained by anomaly detection model selector 2140 is described as the anomaly detection model corresponding to travel route determination parameter group A, and the vehicle information obtained by vehicle data obtainer 2110 is described as vehicle information regarding monitoring target 1000 with vehicle ID V001 illustrated in FIG. 6. FIG. 16 is a flowchart illustrating an example of operation of the anomaly determination process. Moreover, FIGS. 17A and 17B illustrate an example of a procedure of the anomaly determination process.

Anomaly determiner 2150 obtains the current vehicle information regarding monitoring target 1000 obtained by vehicle data obtainer 2110. Then, on the basis of passed intermediate point information included in the vehicle information, anomaly determiner 2150 identifies the routes that monitoring target 1000 has traveled from the origin to date. Then, for the identified routes, anomaly determiner 2150 calculates the cumulative sum of the weights of the routes that monitoring target 1000 has traveled to date, by using the weights of the routes included in the anomaly detection model (S7310). For instance, as illustrated in FIG. 17B, the passed intermediate point of monitoring target 1000 at the date and time indicated by the time stamp: 1612304523 is W2. Since the origin is S1, as indicated by the long-dashed short-dashed line arrow in FIG. 17A, it is identified that the route that monitoring target 1000 has traveled to date is only E1. Thus, the cumulative sum of the weights of the routes that monitoring target 1000 has traveled as of the above-mentioned date and time is calculated as 2 on the basis of the weight of route E1.

Likewise, the passed intermediate points of monitoring target 1000 at the date and time indicated by the time stamp: 1612304527 are points: W2, W3, and W1 (in order). Thus, as indicated by the straight-line arrow in FIG. 17A, it is identified that the routes that monitoring target 1000 has traveled to date are routes: E1, E7, and E4 (in order). Thus, the cumulative sum of the weights of the routes that monitoring target 1000 has traveled as of the above-mentioned date and time is calculated as 12 (2+3+7=12).

Using the weights of the routes included in the anomaly detection model, anomaly determiner 2150 identifies an estimated travel route along which monitoring target 1000 is estimated to travel. Moreover, the cumulative sum of the weight of the identified estimated travel route is calculated (S7320). The estimated travel route is, for example, a route combination with the smallest cumulative sum of the weights of routes among route combinations from the origin to the destination. In FIG. 17A, although there are route combinations from the origin to the destination, the route combination with the smallest cumulative sum of weights is the route from S1 to G1 via E1 and E8 as shown by the dotted line arrow. In the embodiment, the route is the estimated travel route, and the cumulative sum of weights is calculated as 3 (2+1=3). The estimated travel route is identified on the basis of the anomaly detection model, and the anomaly detection model is selected on the basis of the combination of the travel route parameters determined in step S7100. In other words, the estimated travel route is identified according to the combination of the travel route parameters.

Next, anomaly determiner 2150 calculates the degree of anomaly by comparing the cumulative sum of the weights of the routes traveled to date calculated in step S7310 and the cumulative sum of the weight of the estimated travel route calculated in step S7320 (S7330). The degree of anomaly is the degree to which the routes that monitoring target 1000 has traveled to date are anomalous. The degree of anomaly is calculated according to the ratio of the cumulative sum of the weights of the routes traveled to date to the cumulative sum of the weight of the estimated travel route. In FIG. 17B, the cumulative sum of the weights of routes that monitoring target 1000 has traveled as of the date and time indicated by the time stamp: 1612304523 is 2. Since the result of ⅔ is 0.666 . . . , the degree of anomaly is 0.67. Likewise, the cumulative sum of the weights of routes that monitoring target 1000 has traveled as of the date and time indicated by the time stamp: 1612304527 is 12. Since the result of 12/3 is 4, the degree of anomaly is 4. The calculation of the degree of anomaly is not limited to the above. For instance, when the cumulative sum of the weights of the routes traveled to date is large compared to the cumulative sum of the weight of the estimated travel route, simply, a difference between the above two cumulative sums of weight may be calculated as the degree of anomaly.

Anomaly determiner 2150 determines whether to correct the degree of anomaly calculated in step S7330 (S7340). For instance, anomaly determiner 2150 determines that the correction is to be made in the following case: in a state where a travel route determination parameter as a factor that results in monitoring target 1000 selecting an unusual travel route different from normal is identified, the travel route determination parameter that becomes the factor is present within travel route determination parameters related to the current travel route determination of monitoring target 1000. Factors that result in selection of an unusual travel route include to drive in a maintenance mode for an operational reason or other reasons and to drive in a zone requiring continuous manual control. In such cases, a travel route suitable for the maintenance is selected, or a travel route is selected on the basis of the experience of the driver conducting manual driving. Thus, a travel route different from a usual route may be selected. This may result in a deviation from the estimated travel route specified in the trained anomaly detection model, which may decrease the reliability of the calculated degree of anomaly. Thus, by making a correction to lower the degree of anomaly in the above cases, it is possible to suppress false positives. Additionally, anomaly determiner 2150 may determine that the correction is to be made, when the anomaly detection model used is a specific type, or when correction value p for correcting the degree of anomaly is preset in anomaly determiner 2150. When it is determined that the degree of anomaly is to be corrected because of the presence of a parameter that requires anomaly degree correction (Yes in S7340), the procedure proceeds to step S7350. When it is determined that the degree of anomaly is not to be corrected because of the absence of the parameter that requires anomaly degree correction (No in S7340), the procedure proceeds to step S7360.

Anomaly determiner 2150 corrects the degree of anomaly calculated in step S7330 by using correction value p (S7350). Then, the procedure proceeds to step S7360. For instance, a correction to lower the degree of anomaly is made by, for example, dividing the degree of anomaly calculated in step S7330 by correction value p or subtracting correction value p from the degree of anomaly calculated in step S7330.

Anomaly determiner 2150 performs anomaly determination for the degree of anomaly calculated in step S7330 or the degree of anomaly corrected in step S7350 according to whether the degree of anomaly exceeds preset threshold θ (S7360). For instance, as illustrated in FIG. 17B, when threshold θ is set to 3 (when θ=3), if the degree of anomaly is greater than 3, the travel route of monitoring target 1000 to date is determined to be anomalous. In FIG. 17B, since a degree of anomaly of 0.67 is indicated for the route traveled as of the date and time indicated by time stamp: 1612304523, the route is determined to be normal. However, since a degree of anomaly of 4, which exceeds threshold θ, is indicated for the routes traveled as of the date and time indicated by time stamp: 1612304527, the routes are determined to be anomalous. It should be noted that while the threshold θ is set to 3 (θ=3) in the embodiment, other values are also permissible. Moreover, threshold θ may be set for each anomaly detection model, and threshold θ may be set to the same value across the anomaly detection models.

Furthermore, anomaly determiner 2150 transmits the result of anomaly determination and map information to outputter 2200 via display controller 2160 to cause outputter 2200 to output the data. Then, the anomaly determination process ends. It should be noted that only when the degree of anomaly of routes exceeds threshold θ, anomaly determiner 2150 may transmit the result of anomaly determination to outputter 2200 to cause outputter 2200 to output the result. In this way, when the degree of anomaly of the routes is less than or equal to threshold θ, it is possible to cause outputter 2200 not to output anything.

Data transmitted to outputter 2200 via display controller 2160 by anomaly determiner 2150 and then output by outputter 2200 represents a figure including the result of anomaly determination and map information, which are shown as a combination of the data in FIG. 17A and the data in FIG. 17B, for example. Moreover, for instance, information such as the locations, routes, and weights of the routes included in the map information in FIG. 17A may be mapped onto a real map. Then, outputter 2200 may be caused to output the real map with the mapped information. This way, it is possible to provide information allowing for quick visual recognition of a travel route different from a usual route, which helps operator 5200 or the like to recognize the anomaly of the current trip of monitoring target 1000, and facilitates the transition to the following analysis task. Moreover, information regarding the estimated travel route identified in step S7320 may be mapped together with the map information, and then outputter 2200 may be caused to output the data.

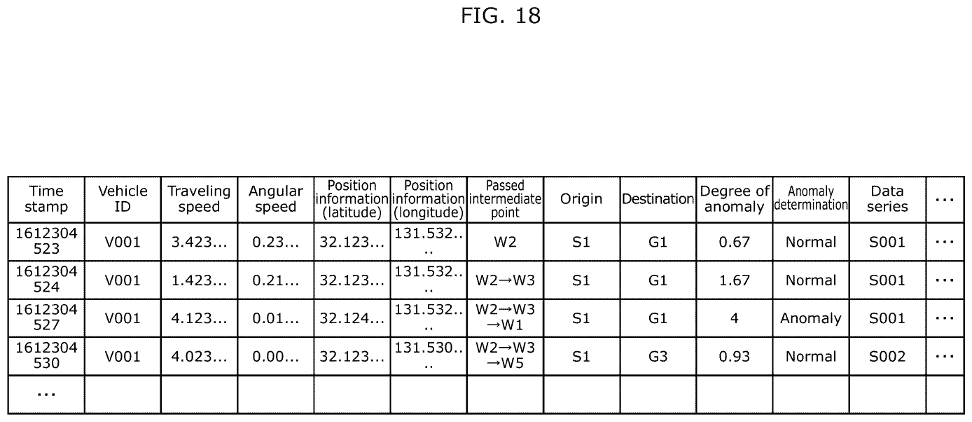

Moreover, in addition to the result of anomaly determination, outputter 2200 may output the current vehicle information regarding monitoring target 1000 obtained by vehicle data obtainer 2110 in step S7310. For instance, outputter 2200 may output data as illustrated in FIG. 18, obtained by merging the result of anomaly determination and the vehicle information obtained by vehicle data obtainer 2110. The data illustrated in FIG. 18 includes pieces of data included in the current vehicle information regarding monitoring target 1000 illustrated in FIG. 6 and the result of anomaly determination. The result of anomaly determination includes, for instance, the degree of anomaly calculated in step S7330 or corrected in step S7350, the result of anomaly determination obtained in step S7360 on the basis of the degree of anomaly, and data series ID representing that anomaly determination has been performed using a sequential series. The same value is assigned to data series IDs for the results of anomaly determination based on vehicle information regarding a continuous sequence of travel of monitoring target 1000 from the origin to the destination. For instance, in FIG. 18, from the time stamp: 1612304523 to the time stamp: 1612304527, same monitoring target 1000 moves from the same origin to the same destination. Thus, the data series for these time stamps are the same data series, and the same value (S001) is assigned to data series IDs. Meanwhile, for the time stamp: 1612304530, same monitoring target 1000 moves from the same origin to a different destination. Thus, data series corresponding to the time stamp is different data series, and a different value (S002) is assigned to data series ID. It should be noted that data series ID is assigned to the result of anomaly determination when the anomaly detection process is performed, and output.

### <Configuration of Model Trainer 2600>

Next, a configuration of model trainer 2600 is described.

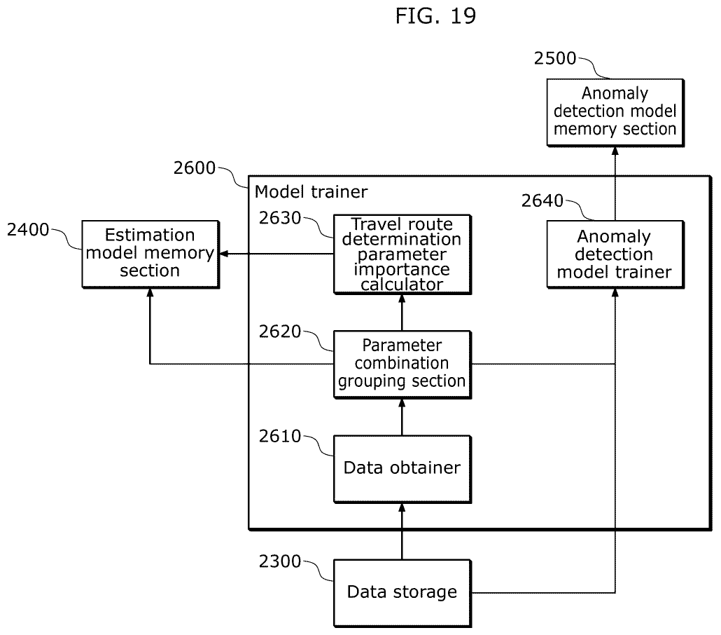

FIG. 19 illustrates a configuration of model trainer 2600 included in anomaly detection device 2000. In FIG. 19, model trainer 2600 includes data obtainer 2610, parameter combination grouping section 2620, travel route determination parameter importance calculator 2630, and anomaly detection model trainer 2640.

On the basis of information regarding an arbitrarily set training duration, data obtainer 2610 obtains, from data storage 2300, vehicle information regarding the previous trips of monitoring target 1000 and a combination of travel route determination parameters concerning travel route determination for each previous trip.

Parameter combination grouping section 2620 obtains data from data obtainer 2610. Next, on the basis of the obtained vehicle information for the previous trips and the obtained combination of the travel route determination parameters concerning travel route determination for each previous trip, parameter combination grouping section 2620 groups, into the same group, combinations of travel route determination parameters that led to similar travel routes. Then, parameter combination grouping section 2620 stores the result of grouping in estimation model memory section 2400 as an estimation model.

Travel route determination parameter importance calculator 2630 obtains grouping information for the combinations of the travel route determination parameters from parameter combination grouping section 2620. Then, in each travel route determination parameter group, travel route determination parameter importance calculator 2630 calculates the importance level of each travel route determination parameter that is a degree of contribution to travel route determination in the group, and adds calculation results to the estimation model stored in estimation model memory section 2400.

Anomaly detection model trainer 2640 obtains, from data storage 2300, past travel data and travel route determination parameters concerning travel route determination for each trip. Moreover, anomaly detection model trainer 2640 obtains, from parameter combination grouping section 2620, the travel route determination parameter group and information indicating travel route usage frequency corresponding to the travel route determination parameter group. Then, anomaly detection model trainer 2640 trains an anomaly detection model for each group, and stores the trained anomaly detection model in anomaly detection model memory section 2500.

### <Operation of Model Training Process>

Next, a model training process is described.

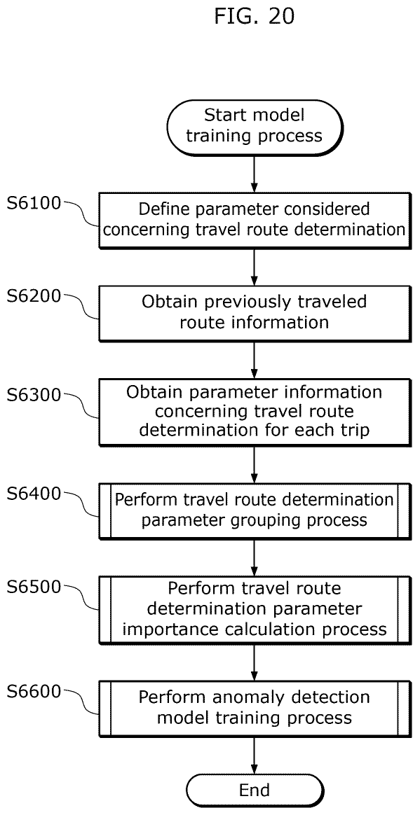

FIG. 20 is a flowchart illustrating an example of operation of the model training process.

Anomaly detection device 2000 defines travel route determination parameters considered relevant to travel route determination out of parameters that may be included in the information obtained from external information source 3000 (S6100). Specifically, anomaly detection device 2000 defines, as travel route determination parameters, those parameters preset by operator 5200 that are relevant to travel route determination. Information regarding the defined travel route determination parameters is stored in each of data storage 2300, anomaly detector 2100, model trainer 2600, and so forth.

Parameters concerning travel route determination are set by operator 5200 after being examined on the basis of the type and content of a service utilizing an autonomous vehicle that is monitoring target 1000. For instance, when monitoring target 1000 is a material-handling autonomous vehicle, a parameter indicating information regarding the type of a transported cargo and a parameter indicating information regarding the weather are set as parameters concerning travel route determination. In addition, a parameter indicating road status information and a parameter indicating road traffic information may be set as parameters concerning travel route determination. Moreover, typically, in various services utilizing autonomous vehicles, autonomous vehicle service providers employ an optimal travel route determination algorithm that does not interfere with operations. Thus, various parameters may be set as parameters concerning travel route determination, depending on the usage case of an autonomous vehicle.

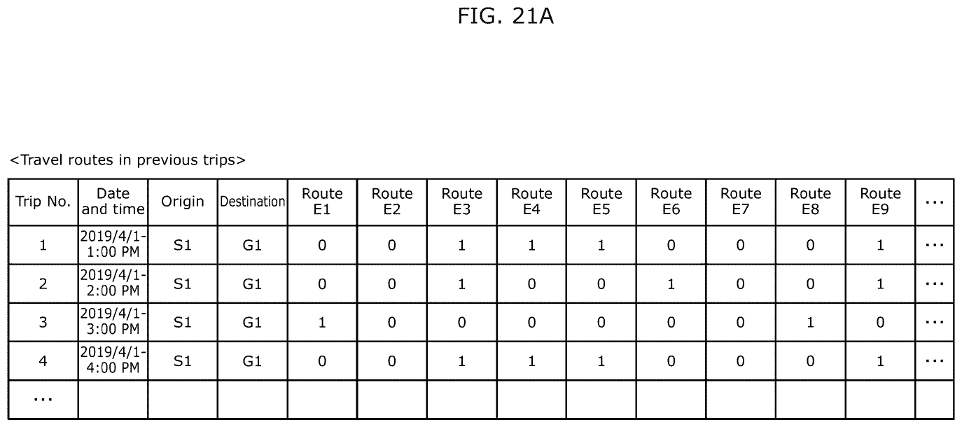

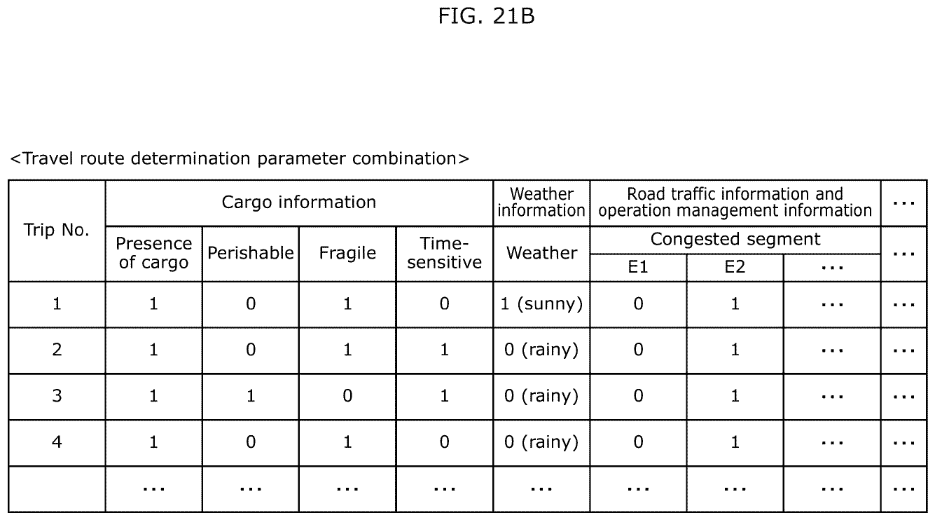

Data obtainer 2610 obtains, from data storage 2300, travel route information included in the vehicle information regarding the previous trips of monitoring target 1000 (S6200). The travel route information includes at least the origin, the destination, and each route that monitoring target 1000 traveled. It should be noted that the travel route information may include information regarding the intermediate points that monitoring target 1000 passed. FIG. 21A illustrates an example of obtained travel route information for previous trips. In FIG. 21A, the travel route information includes trip No. that is an identifier assigned for each trip of monitoring target 1000 from the origin to the destination, the date and time indicating the start date and time of the trip or the end date and time of the trip, the origin, the destination, and information indicating whether each route was traveled. The information indicating whether each route was traveled takes a value of 0 or 1, and indicates that monitoring target 1000 traveled the routes assigned a value of 1 and that monitoring target 1000 did not travel the routes assigned a value of 0. For instance, regarding the trip with trip No. 1, it is shown that monitoring target 1000 started from origin S1, traveled along routes E3, E4, E5, and E9, and arrived at destination G1.

Data obtainer 2610 obtains, from data storage 2300, combinations of travel route determination parameters concerning travel route determination for the previous trips corresponding to the travel route information obtained in step S6200 (S6300). FIG. 21B illustrates the combinations of the travel route determination parameters for the previous trips illustrated in FIG. 21A. In FIG. 21B, a combination of travel route determination parameters includes trip No. corresponding to trip No. in the travel route information and the travel route determination parameters. It should be noted that in the following description, the same travel route determination parameter is shown for the same congested segment in trips No. 1 through No. 4.

Parameter combination grouping section 2620 obtains the previously traveled route information obtained by data obtainer 2610 in step S6100 and step S6200, and corresponding combinations of travel route determination parameters. Then, parameter combination grouping section 2620 performs the travel route determination parameter grouping process on the basis of the previously traveled route information, and performs grouping of the combinations of the travel route determination parameters (S6400). Thus, parameter combination grouping section 2620 creates travel route determination parameter groups, and links each group with the previously traveled route information.

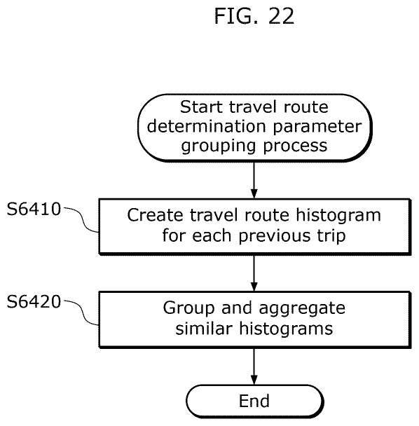

The travel route determination parameter grouping process is described below. FIG. 22 is a flowchart illustrating an example of operation of a travel route determination parameter grouping process performed by parameter combination grouping section 2620.

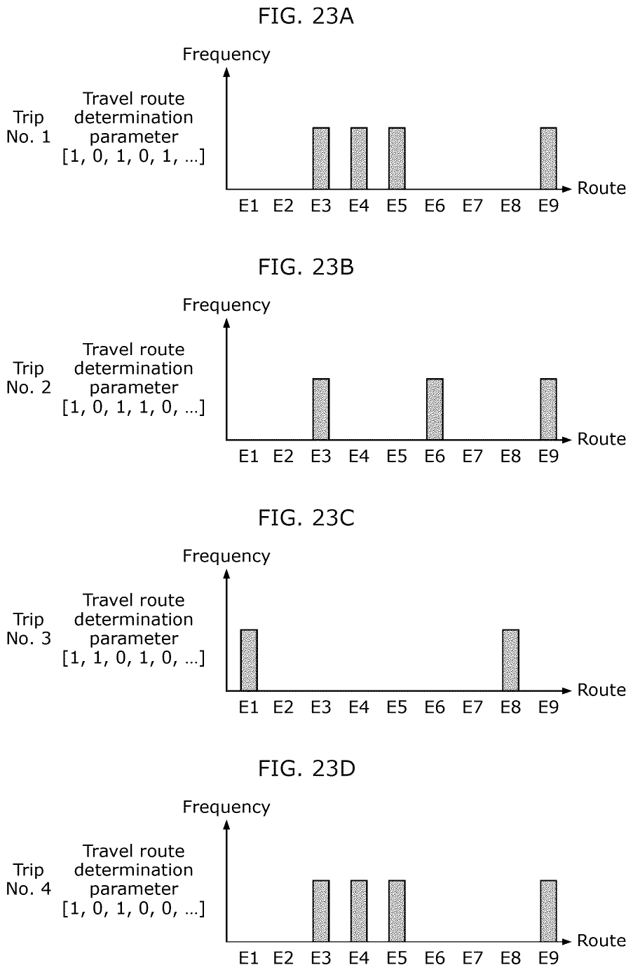

Parameter combination grouping section 2620 creates a histogram regarding the travel route usage frequency for each previous trip on the basis of the previously traveled route information (S6410). A histogram for each previous trip illustrated in FIG. 21A is a histogram as illustrated in FIGS. 23A to 23D, with the vertical axis showing usage frequency. It should be noted that, for simplicity, FIGS. 23A to 23D show only the categories of “presence of cargo”, “perishable”, “fragile”, “time-sensitive”, and “weather” as a combination of travel route determination parameters corresponding to the previously traveled route information.

Then, parameter combination grouping section 2620 performs grouping on histograms that exhibit similar tendencies, on the basis of histograms indicating the travel route usage frequency in each previous trip (S6420). Then, parameter combination grouping section 2620 aggregates the grouped histograms into a single histogram. Moreover, parameter combination grouping section 2620 groups combinations of travel route determination parameters corresponding to the grouped histograms, to make a travel route determination parameter group, and ends the travel route determination parameter grouping process.

A method for calculating the distance between two histograms using, for example, Earth Mover's Distance (EMD) algorithm can be used as a method for calculating the degree of similarity indicating how similar the trend of each histogram is. Then, histograms with a close EMD distance, that is, similar histograms are successively grouped together by agglomerative clustering, and successively aggregated. This way, histograms are aggregated into groups by grouping similar-tendency histograms together. Then, an aggregation result is stored in estimation model memory section 2400 and transmitted to anomaly detection model trainer 2640.

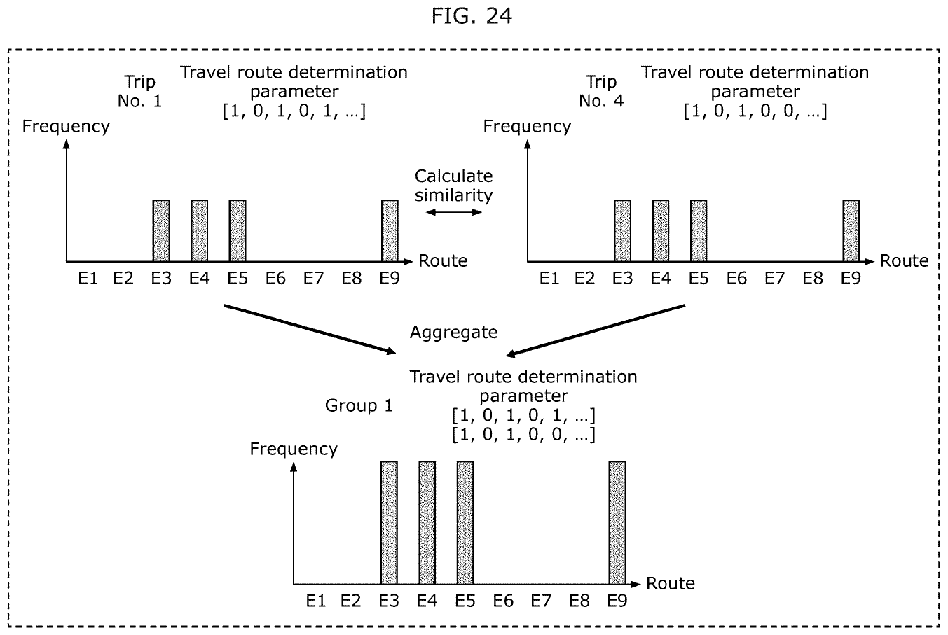

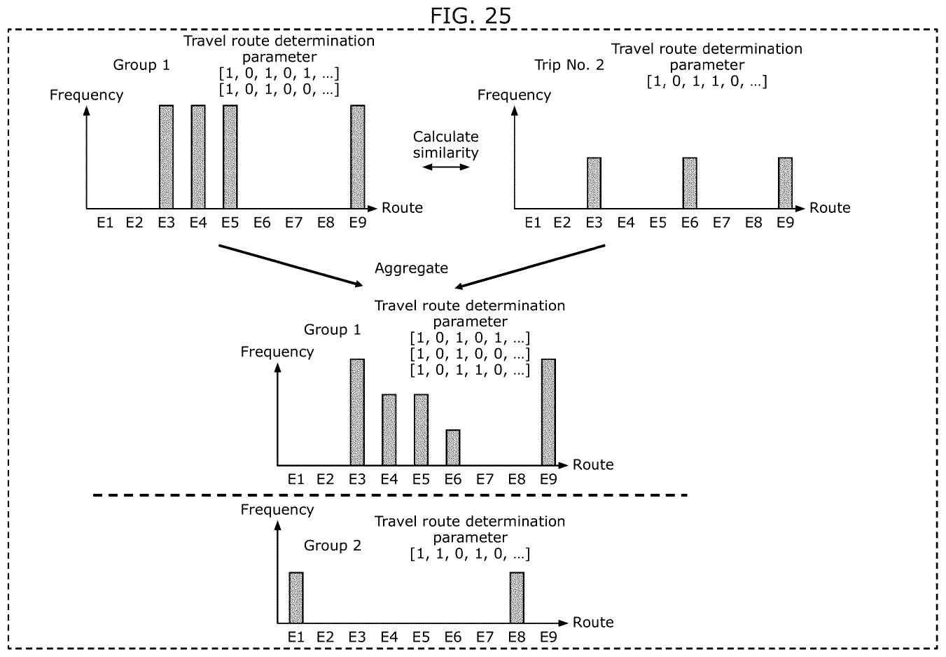

FIG. 24 and FIG. 25 each illustrate an example of the process of grouping and aggregating the four histograms illustrated in FIGS. 23A to 23D. First, parameter combination grouping section 2620 calculates the degree of similarity for all pairs of the four histograms illustrated in FIGS. 23A to 23D. Next, parameter combination grouping section 2620 groups and aggregates the pair of histograms that is greater than or equal to a similarity threshold and that has the highest degree of similarity. In the embodiment, as illustrated in FIG. 24, the pair of the histograms indicated by trip No. 1 and trip No. 4 is the pair with the highest degree of similarity. Thus, the histograms for trip No. 1 and trip No. 4 are grouped and aggregated as group 1. At the same time, combinations of travel route determination parameters are grouped together, which means there are two combinations of travel route determination parameters in the group.

Next, parameter combination grouping section 2620 calculates the degree of similarity for all pairs of the histogram aggregated as group 1, the histogram indicated by trip No. 2, which is not grouped, and the histogram indicated by trip No. 3, which is not grouped. It should be noted that when there are two or more histogram groups, the degree of similarity between the groups may be calculated, and when the degree of similarity for a pair of groups is greater than or equal to a threshold, the groups may be grouped together as one group. Then, parameter combination grouping section 2620 groups and aggregates the pair of histograms that is greater than or equal to a similarity threshold and has the highest degree of similarity. In the embodiment, as illustrated in FIG. 25, the pair of the histogram indicated by trip No. 2 and the histogram of group 1 is the pair with the highest degree of similarity. Thus, the histograms for trip No. 2 and group 1 are grouped together. That is, the histogram indicated by trip No. 2 is aggregated into group 1. At the same time, combinations of travel route determination parameters are grouped together, which means that there are three combinations of travel route determination parameters in the group.

Parameter combination grouping section 2620 successively performs similar grouping until the degree of similarity between histograms falls below the threshold. When the calculated degree of similarity falls below the threshold, parameter combination grouping section 2620 treats each ungrouped histogram as an independent group, and ends the grouping. In the embodiment, as illustrated in FIG. 25, the degree of similarity between the aggregated histogram made as group 1 and the ungrouped histogram indicated by trip No. 3 is less than the threshold. Thus, the histogram indicated by trip No. 3 is not grouped into group 1, and is treated as independent group 2.

In this way, each group made by grouping and having one or more combinations of travel route determination parameters is stored in estimation model memory section 2400 as a travel route determination parameter group. Moreover, the aggregated histograms corresponding to the travel route determination parameter groups are transmitted to anomaly detection model trainer 2640.

In this way, by performing the travel route determination parameter grouping process, it is possible to aggregate combinations of travel route determination parameters using similar travel routes. Thus, even if the number of combinations of travel route determination parameters increases, it is possible to suppress the number of anomaly detection models from increasing. Thus, in comparison with a case where an anomaly detection model is simply selected for each combination of travel route determination parameters, it is possible to suppress occurrence of issues such as having a small number of data items available for training and the risk of overfitting.

The description now returns to the model training process.

Travel route determination parameter importance calculator 2630 obtains, from parameter combination grouping section 2620, grouping information for the combinations of travel route determination parameters grouped together in step S6400. Next, travel route determination parameter importance calculator 2630 performs a travel route determination parameter importance calculation process, and calculates, for each of travel route determination parameter groups, the importance level of each travel route determination parameter concerning travel route determination in the group (S6500). Then, travel route determination parameter importance calculator 2630 adds the calculated importance level of each travel route determination parameter to the travel route determination parameter group to create an estimation model, and stores the estimation model in estimation model memory section 2400.

The travel route determination parameter importance calculation process is described below.

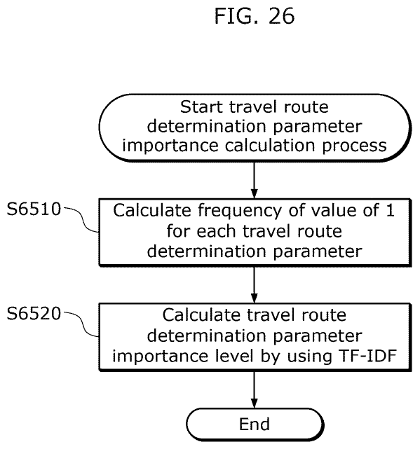

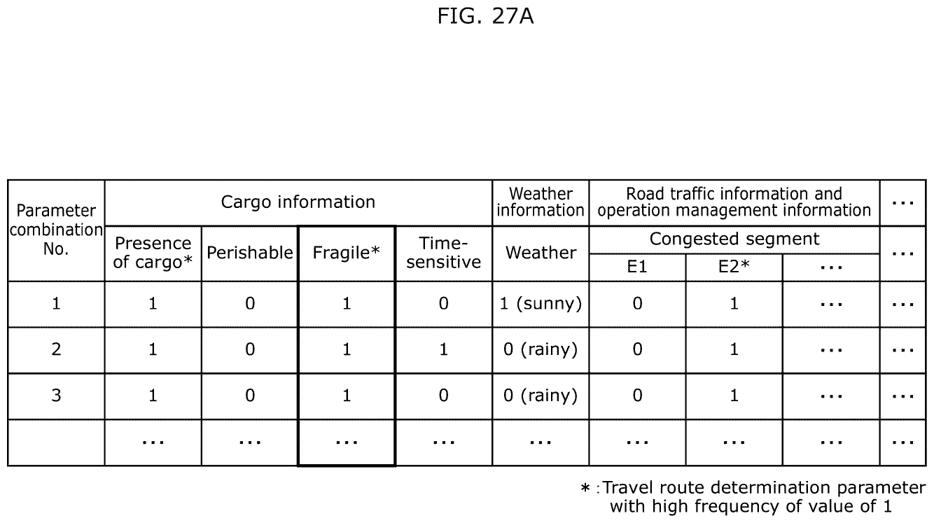

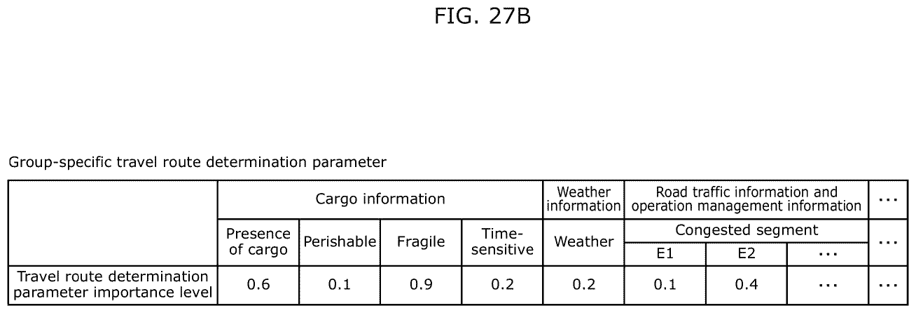

FIG. 26 is a flowchart illustrating an example of operation of a travel route determination parameter importance calculation process performed by travel route determination parameter importance calculator 2630. Moreover, FIGS. 27A and 27B illustrate an example of a procedure of the travel route determination parameter importance calculation process for the travel route determination parameter group indicated by group 1 in FIG. 25 and including the three combinations of travel route determination parameters.

First, travel route determination parameter importance calculator 2630 calculates the frequency of a value of 1 for each travel route determination parameter in each group made by grouping in step S6400 (S6510). Moreover, travel route determination parameter importance calculator 2630 identifies a travel route determination parameter with a high frequency of a value of 1. For instance, in the travel route determination parameter group illustrated in FIG. 27A, “presence of cargo”, “fragile”, and “(congestion segment) E2” are identified as travel route determination parameters with a high frequency of a value of 1.

Next, for each travel route determination parameter, the percentage of other groups where it is identified as a travel route determination parameter with a high frequency of a value of 1 is calculated. Then, on the basis of the calculated percentage and the frequency of a value of 1 calculated in step S6510, the importance level of each travel route determination parameter in each group is calculated by a team frequency-inverse document frequency (TF-IDF) method (S6520). That is, a travel route determination parameter with a high frequency of a value of 1 that has a low percentage of other groups where it is identified as a travel route determination parameter with a high frequency of a value of 1 is regarded as a group-specific travel route determination parameter. Thus, the importance level thereof is calculated to be high. Moreover, even if a travel route determination parameter has a high frequency of a value of 1 within the group, when the travel route determination parameter has a high percentage of the other groups where it is identified as a travel route determination parameter with a high frequency of a value of 1, the importance level is calculated to be low in comparison with the above case. Moreover, the importance level of a travel route determination parameter with a low frequency of a value of 1 within the group is calculated to be even lower in comparison with the above case. It should be noted that the importance level may take a value ranging from 0 to 1. Moreover, a group-specific travel route determination parameter is not limited to just one parameter, and there are may be travel route determination parameters whose importance levels are calculated to be high.

For instance, in the travel route determination parameter group illustrated in FIG. 27A, the importance levels of the travel route determination parameters with a high frequency of a value of 1, which are “presence of cargo”, “fragile”, and “(congestion segment) E2”, are calculated to be high. Furthermore, regarding the travel route determination parameter “fragile”, when the travel route determination parameter has a low percentage of other groups where it is identified as a travel route determination parameter with a high frequency of a value of 1, the travel route determination parameter is regarded as a group-specific travel route determination parameter. Thus, the importance level thereof is calculated to be an even higher value of 0.9, as illustrated in FIG. 27B.

In this way, by setting the importance level of each travel route determination parameter, in the anomaly detection model selection process, upon emergence of a new combination of travel route determination parameters that has not been observed before, it is possible to calculate the degree of similarity indicating a group similar to the new combination of travel route determination parameters. Thus, even if the combination is a new combination of travel route determination parameters, an appropriate travel route determination parameter group can be selected.

The description now returns to the model training process.

Anomaly detection model trainer 2640 obtains, from parameter combination grouping section 2620, the travel route determination parameter groups made by grouping in step S6400. Moreover, anomaly detection model trainer 2640 obtains an aggregated histogram corresponding to each travel route determination parameter group and indicating travel route usage frequency. Then, anomaly detection model trainer 2640 performs the anomaly detection model training process (S6600), stores the travel route determination parameter groups including trained anomaly detection models in anomaly detection model memory section 2500, and ends the model training process.

Next, the anomaly detection model training process is described.

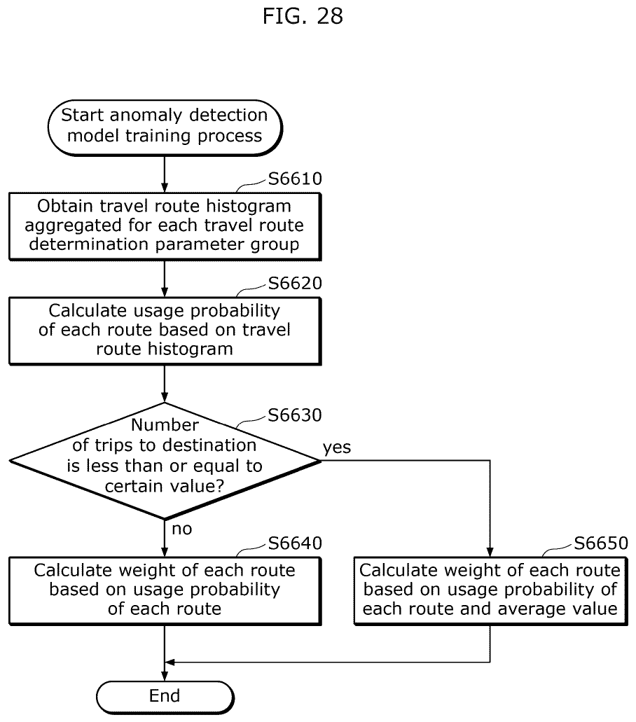

FIG. 28 is a flowchart illustrating an example of operation of an anomaly detection model training process performed by anomaly detection model trainer 2640. In the anomaly detection model training process, an anomaly detection model is trained that determines whether a travel route is valid or anomalous for each travel route determination parameter group.

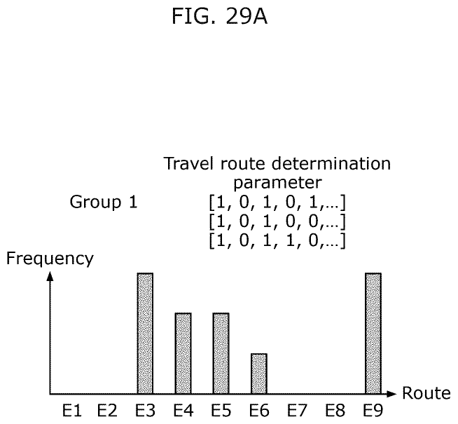

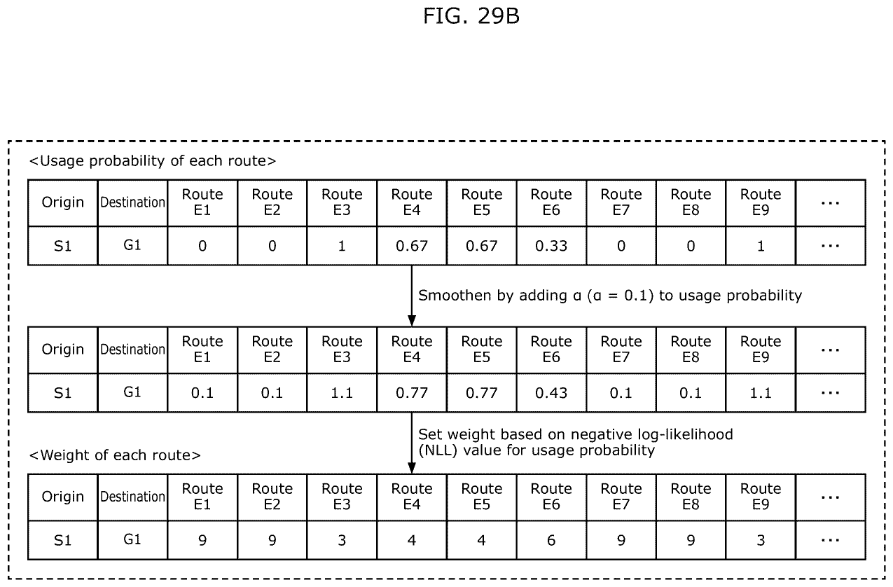

One anomaly detection model is associated with each travel route determination parameter group, and is a model that defines the usage frequency for each of travel routes on the basis of travel route determination parameters within the travel route determination parameter group. In the anomaly detection process, by using the anomaly detection model, it is possible to determine whether the travel route selected for a trip of monitoring target 1000 is valid or anomalous. For instance, as illustrated in FIGS. 14A to 14C, the anomaly detection model includes the origin, the destination, and the weights set according to the usage frequency for routes between the origin and the destination. FIGS. 29A and 29B illustrate an example of a training process of an anomaly detection model. FIG. 29 illustrates a training process of an anomaly detection model corresponding to a travel route determination parameter group made as group 1 by grouping in step S6420.

Anomaly detection model trainer 2640 obtains a travel route histogram for each travel route determination parameter group that is a histogram aggregated in step S6400 (S6610). For instance, a histogram, as illustrated in FIG. 29A, indicating the usage frequency of each route is obtained.

Next, anomaly detection model trainer 2640 calculates the usage probability of each route on the basis of the travel route histogram obtained in step S6610 (S6620). For instance, in FIG. 29B, the usage probabilities of routes E3 and E9 are both calculated as 1, the usage probabilities of routes E4 and E5 are both calculated as 0.67, and the usage probability of route E6 is calculated as 0.33. Furthermore, if there is a route that has never been used and has a calculated usage probability of 0, anomaly detection model trainer 2640 performs smoothing by adding a small value of a to all routes. As illustrated in FIG. 29B, a is, for example, 0.1.

Regarding the previous trips of monitoring target 1000, anomaly detection model trainer 2640 obtains the number of cases where a combination of origin and destination indicated by each travel route determination parameter group matches a combination of origin and destination in each trip. That is, the number of matching cases indicates the number of times monitoring target 1000 traveled according to the combination of origin and destination indicated by each travel route determination parameter group. Then, anomaly detection model trainer 2640 determines whether the number of trips for each travel route determination parameter group subject to the anomaly detection model training process is less than or equal to a threshold (S6630). When it is determined that the number of trips is not less than or equal to the threshold (No in step S6630), the procedure proceeds to step S6640, and when it is determined that the number of trips is less than or equal to the threshold (Yes in step S6630), the procedure proceeds to step S6650.

Anomaly detection model trainer 2640 calculates the cost of using each route from the usage probability of each route calculated in step S6620, and sets the weight of each route on the basis of the cost of using each route (S6640). The usage cost of each route is calculated by, for example, taking a negative log-likelihood for a usage probability of each route. Moreover, the weight of each route is set on the basis of, for example, the ratios of the usage costs of the routes. In FIG. 29B, the weight of route E1 is set to 9, the weight of route E2 is set to 9, the weight of route E3 is set to 3, and so forth. It should be noted that the weight of each route may be appropriately scaled and set as long as the ratios remain unchanged. For instance, scaling weights on the basis of the maximum value of the cumulative sum of the weights of routes between an origin and a destination can facilitate threshold setting in anomaly determination in step S7360.

Alternatively, anomaly detection model trainer 2640 calculates the usage cost of each route on the basis of values obtained by adding the average value of the usage probabilities of routes in all travel route determination parameter groups with the same combination of origin and destination, to the usage probabilities of the routes calculated in step S6620, and sets the weight of each route (S6650). In this way, even when the number of trips from the origin to the destination indicated in the travel route determination parameter group is less than or equal to the threshold and sufficient training may not have been performed, it is possible to set weights in consideration of the average value of usage probabilities across all data. Thus, it is possible to suppress the deterioration of the accuracy of anomaly detection and an increase in false positives due to underfitting.

### INDUSTRIAL APPLICABILITY

The present disclosure is widely applicable to an anomaly detection device that detects an anomaly concerning autonomous vehicle travel.

1. An anomaly detection method for detecting an anomaly in an autonomous vehicle that autonomously travels from an origin to a destination, the anomaly detection method being performed by a computer and comprising:
an obtainment process for obtaining a travel route along which the autonomous vehicle has traveled from the origin up to a given time point; and
a detection process for (i) reading out information regarding a plurality of routes traversable by the autonomous vehicle from the origin to the destination, (ii) identifying, based on the information regarding the plurality of routes read out, one of the plurality of routes as an estimated travel route of the autonomous vehicle from the origin to the destination, (iii) calculating a degree of anomaly representing an extent to which the travel route up to the given time point deviates from the estimated travel route identified, and (iv) detecting an occurrence of an anomaly in the autonomous vehicle when the degree of anomaly calculated exceeds a predetermined threshold.

2. The anomaly detection method according to claim 1, wherein
the information regarding the plurality of routes is further obtained when the travel route up to the given time point is obtained or every time a predetermined duration has passed, and
the information regarding the plurality of routes read out to identify the estimated travel route includes previously obtained information regarding the plurality of routes.

3. The anomaly detection method according to claim 1, wherein
the detection process further includes:
displaying, when an anomaly in the autonomous vehicle is detected, a detection result showing the occurrence of the anomaly in the autonomous vehicle and predetermined map information showing the travel route from the origin up to the given time point and the estimated travel route.

4. The anomaly detection method according to claim 1, wherein
the information regarding the plurality of routes is a travel route determination parameter,
the travel route determination parameter is a parameter including a combination of values each indicating whether a corresponding one of events is present, the events being events that potentially affect determination of a travel route from the origin to the destination by the autonomous vehicle, and
in the detection process, the estimated travel route is identified based on the travel route determination parameter.

5. The anomaly detection method according to claim 4, wherein
the information regarding the plurality of routes includes at least one of (i) a distance from the origin to the destination in each of the plurality of routes or (ii) a duration required for each of the plurality of routes of the autonomous vehicle from the origin to the destination.

6. The anomaly detection method according to claim 4, wherein
the information regarding the plurality of routes includes information indicating an event that potentially becomes an obstruction when the autonomous vehicle travels along each of the plurality of routes at the given time point.

7. The anomaly detection method according to claim 6, wherein
the information indicating the event that potentially becomes the obstruction when the autonomous vehicle travels along each of the plurality of routes includes information indicating whether each of the plurality of routes is traversable by the autonomous vehicle.

8. The anomaly detection method according to claim 4, wherein
the autonomous vehicle is a vehicle used to transport cargo,
the obtainment process further includes obtaining information regarding the cargo transported by the autonomous vehicle,
the information regarding the cargo is the travel route determination parameter including at least one of (i) one or more information items each indicating an attribute of the cargo or (ii) one or more information items each indicating a transportation condition of the cargo, and
in the detection process, the estimated travel route is identified based on the information regarding the plurality of routes and the information regarding the cargo.

9. The anomaly detection method according to claim 4, further comprising:
a selection and readout process for selecting and reading out an anomaly detection model from among anomaly detection models corresponding to travel route determination parameters each of which is the travel route determination parameter, wherein
one of the plurality of routes is determined for each of the anomaly detection models,
in the selection and readout process, an anomaly detection model corresponding to the travel route determination parameter is selected and read out, and
in the detection process, a route determined for the anomaly detection model selected and read out is identified as the estimated travel route.

10. The anomaly detection method according to claim 9, wherein
the one of the plurality of routes determined for each of the anomaly detection models is updated to any one of the plurality of routes at predetermined intervals.

11. The anomaly detection method according to claim 10, wherein
in each of the anomaly detection models, (i) the plurality of routes and (ii) a route weight of each of the plurality of routes that indicates a measure of probability of the autonomous vehicle traveling the route are specified,
the route weight is updated at predetermined intervals, and
based on the route weight of each of the plurality of routes, one of the plurality of routes is determined as an updated route in each of the anomaly detection models.

12. The anomaly detection method according to claim 10, further comprising:
a training process for training each of the anomaly detection models, wherein
the training process includes the following performed at predetermined intervals:
obtaining previously traveled routes that are travel routes in previous trips of the autonomous vehicle with a same combination of values of the travel route determination parameter, among previous trips of the autonomous vehicle from the origin to the destination;
calculating, from the previously traveled routes obtained, a frequency at which the autonomous vehicle traveled along each of the plurality of routes; and
determining, based on the frequency calculated, one of the plurality of routes as a route for an anomaly detection model corresponding to the travel route determination parameter.

13. The anomaly detection method according to claim 9, wherein
each of the plurality of routes is constituted by a combination of one or more segments each connecting two locations out of given locations on the plurality of routes,
in each of the anomaly detection models, a segment weight is determined per segment of the one or more segments, the segment weight indicating a measure of probability of the autonomous vehicle traveling each of the one or more segments,
the detection process includes:
calculating the degree of anomaly of the travel route from the origin up to the given time point, based on a ratio of (i) a cumulative sum of the segment weight determined per segment of the one or more segments included in the travel route from the origin up to the given time point to (ii) a cumulative sum of the segment weight determined per segment of the one or more segments included in the estimated travel route, and
when the degree of anomaly calculated exceeds the predetermined threshold, the occurrence of the anomaly in the autonomous vehicle is detected.

14. The anomaly detection method according to claim 13, wherein
the detection process includes:
making a correction to decrease the degree of anomaly when an event that leads to the autonomous vehicle determining an unusual travel route different from normal is defined and when the travel route determination parameter is a parameter with a combination including a value indicating presence of the event, and
when the degree of anomaly after the correction exceeds the predetermined threshold, the occurrence of the anomaly in the autonomous vehicle is detected.

15. The anomaly detection method according to claim 9, wherein
parameter groups are set to classify the travel route determination parameters,
one or more travel route determination parameters each of which is the travel route determination parameter are determined for each of the parameter groups,
the anomaly detection models correspond to the parameter groups, and
the detection process includes:
determining, from the parameter groups, a parameter group for which the travel route determination parameter is determined;
selecting and reading out an anomaly detection model corresponding to the parameter group for which the travel route determination parameter is determined; and
identifying, as the estimated travel route, a route specified by the anomaly detection model selected and read out.

16. The anomaly detection method according to claim 15, wherein
in each of the parameter groups, an importance level representing a tendency of a value included in the combination across the one or more travel route determination parameters is determined,
the importance level is constituted by a combination of values corresponding to the combination of the values indicated by the travel route determination parameter, and
in the detection process, when none of the parameter groups specifies the travel route determination parameter, an anomaly detection model corresponding to a parameter group with the importance level most similar to the importance level of the travel route determination parameter among the parameter groups is selected and read out.

17. The anomaly detection method according to claim 15, further comprising:
a training process for training each of the anomaly detection models, wherein
the training process includes:
obtaining (i) the travel route determination parameters obtained in previous trips of the autonomous vehicle from the origin to the destination and (ii) previously traveled routes that are travel routes of the autonomous vehicle in the previous trips; and
creating the parameter groups by grouping, as a same parameter group, the travel route determination parameters determined for one or more previous trips where the previously traveled routes are similar.

18. The anomaly detection method according to claim 17, wherein
the training process further includes:
creating the anomaly detection model by (i) calculating, using each of the previously traveled routes that are similar and correspond to one of the parameter groups created through grouping, a frequency at which the autonomous vehicle traveled along each of the plurality of routes, and (ii) determining a route weight of each of the plurality of routes based on the frequency calculated.

19. An anomaly detection device that detects an anomaly in an autonomous vehicle that autonomously travels from an origin to a destination, the anomaly detection device comprising:
an obtainer that obtains a travel route along which the autonomous vehicle has traveled from the origin up to a given time point;
a memory section that stores information regarding a plurality of routes traversable by the autonomous vehicle from the origin to the destination; and
an anomaly detector that (i) identifies, based on the information regarding the plurality of routes read out from the memory section, one of the plurality of routes as an estimated travel route of the autonomous vehicle from the origin to the destination, (ii) calculates a degree of anomaly representing an extent to which the travel route up to the given time point deviates from the estimated travel route identified, and (iii) detects an occurrence of an anomaly in the autonomous vehicle when the degree of anomaly calculated exceeds a predetermined threshold.

20. A non-transitory computer-readable recording medium having recorded thereon a program for causing the computer to execute the anomaly detection method according to claim 1.
